(19) United States
(12) Patent Application Publication
(10) Pub. No.: US 2022/0191417 A1
(43) Pub. Date: Jun. 16, 2022

(54) SOLID-STATE IMAGING DEVICE AND IMAGING DEVICE

(71) Applicant: SONY SEMICONDUCTOR SOLUTIONS CORPORATION, KANAGAWA (JP)

(72) Inventor: FUTA MOCHIZUKI, KANAGAWA (JP)

(21) Appl. No.: 17/310,487

(22) PCT Filed: Feb. 5, 2020
(86) PCT No.: PCT/JP2020/004411

§ 371 Date: Aug. 5, 2021

(30) Foreign Application Priority Data
Feb. 15, 2019 (JP) 2019-025531

(51) Int. Cl. H04N 5/374; H04N 5/347; H04N 5/3745; H04N 5/369; H04N 5/376

(52) U.S. Cl. CPC H04N 5/3741; H04N 5/347; H04N 5/376; H04N 5/3698; H04N 5/3745

(57) ABSTRACT

To improve image quality. A solid-state imaging device according to an embodiment includes: a plurality of unit pixels (310) each of which includes a first photoelectric conversion element (311) that generates an electric charge corresponding to an amount of light received, and a detector (312) that detects a firing of an address event based on the electric charge generated in the first photoelectric conversion element, the plurality of unit pixels being arranged in a matrix; and a reset controller (202) that resets one or more first unit pixels in which the firing of the address event has been detected among the plurality of unit pixels, in which the reset controller periodically resets one or more second unit pixels among the plurality of unit pixels.

### FIELD

The present disclosure relates to a solid-state imaging device and an imaging device.

### BACKGROUND

In conventional technologies, a synchronous solid-state imaging device that performs imaging of image data (frames) in synchronization with a synchronization signal such as a vertical synchronization signal has been used in an imaging device or the like. This general synchronous solid-state imaging device can only acquire image data every synchronization signal period (for example, 1/60 second), making it difficult to deal with faster processing when required in fields related to transportation, robots, or the like. To overcome this, there has been proposed an asynchronous solid-state imaging elements equipped with a detection circuit that detects in real time that the amount of received light exceeds a threshold, as an address event. This asynchronous solid-state imaging device is also referred to as a Dynamic Vision Sensor (DVS).

Furthermore, there has been developed, in recent years, a DVS that generates image data by reading out a luminance value corresponding to the amount of received light from a pixel in which a firing of an address event is detected.

### CITATION LIST

### Patent Literature

Patent Literature 1: JP 2016-533140 A

### SUMMARY

### Technical Problem

However, a conventional DVS has had a problem due to the fact that only a pixel in which an address event has been detected becomes a target of readout of the luminance value. That is, in scenes where the address event detection in all unit pixels where the luminance change should have occurred is not successful due to insufficient contrast in cases, for example, where the background and a moving object have similar colors or shooting is performed in the dark, an output image contains irregular hole-like unnatural missing portions, leading to image quality deterioration.

In view of this, the present disclosure proposes a solid-state imaging device and an imaging device capable of improving image quality.

### Solution to Problem

To solve the above-described problem, a solid-state imaging device according to one aspect of the present disclosure comprises: a plurality of unit pixels each of which includes a first photoelectric conversion element that generates an electric charge corresponding to an amount of light received and includes a detector that detects a firing of an address event based on the electric charge generated in the first photoelectric conversion element, the plurality of unit pixels being arranged in a matrix; and a reset controller that resets one or more first unit pixels in which the firing of the address event has been detected, among the plurality of unit pixels, wherein the reset controller periodically resets one or more second unit pixels among the plurality of unit pixels.

### BRIEF DESCRIPTION OF DRAWINGS

FIG. 1 is a block diagram illustrating a schematic configuration example of an imaging device according to a first embodiment.

FIG. 2 is a block diagram illustrating a schematic configuration example of a solid-state imaging device according to the first embodiment.

FIG. 3 is a circuit diagram illustrating a schematic configuration example of a unit pixel according to the first embodiment.

FIG. 4 is a waveform diagram illustrating a potential change of a capacitor in FIG. 3.

FIG. 5 is a waveform diagram illustrating an output signal that is output from a comparator in FIG. 3.

FIG. 6 is a diagram illustrating operations of the logic circuit in FIG. 3.

FIG. 7 is a diagram illustrating an operation example of the solid-state imaging device according to the first embodiment (Part 1).

FIG. 8 is a diagram illustrating an operation example of the solid-state imaging device according to the first embodiment (Part 2).

FIG. 9 is a diagram illustrating an operation example of the solid-state imaging device according to the first embodiment (Part 3).

FIG. 10 is a diagram illustrating an operation example of the solid-state imaging device according to the first embodiment (Part 4).

FIG. 11 is a diagram illustrating an operation example of the solid-state imaging device according to the first embodiment (Part 5).

FIG. 12 is a circuit diagram illustrating a schematic configuration example of a row signal generation circuit/column signal generation circuit according to the first embodiment.

FIG. 13 is a diagram illustrating that an object has passed within an angle of view of a pixel array unit according to the first embodiment.

FIG. 14 is a diagram illustrating an example of a unit pixel that detects a firing of an address event when an object has passed within the angle of view illustrated in FIG. 13.

FIG. 15 is a diagram illustrating image data generated by firing detection of the address event illustrated in FIG. 14.

FIG. 16 is a diagram illustrating an example of image data periodically acquired in the first embodiment.

FIG. 17 is a diagram illustrating superposition of image data acquired based on the firing of the address event and image data acquired periodically according to the first embodiment.

FIG. 18 is a diagram illustrating an example of image data generated by the superposition illustrated in FIG. 17.

FIG. 19 is a schematic diagram illustrating an example of a column pattern signal held in a column signal generation circuit in a first example of a second embodiment.

FIG. 20 is a diagram illustrating superposition of image data acquired based on a firing of an address event and image data acquired periodically according to the first example of the second embodiment.

FIG. 21 is a schematic diagram illustrating an example of a row pattern signal held in a row signal generation circuit in a second example of the second embodiment.

FIG. 22 is a diagram illustrating superposition of image data acquired based on a firing of an address event and image data acquired periodically according to the second example of the second embodiment.

FIG. 23 is a schematic diagram illustrating an example of a row pattern signal held in a row signal generation circuit and a column pattern signal held in a column signal generation circuit in a third example of the second embodiment.

FIG. 24 is a diagram illustrating superposition of image data acquired based on a firing of an address event and image data acquired periodically according to the third example of the second embodiment.

FIG. 25 is a schematic diagram illustrating an example of a column pattern signal held in a column signal generation circuit in a first example of a third embodiment.

FIG. 26 is a diagram illustrating a periodic shift in the row direction in a unit pixel from which a pixel signal is periodically read out in the first example of the third embodiment.

FIG. 27 is a schematic diagram illustrating an example of a row pattern signal held in a row signal generation circuit in a second example of the third embodiment.

FIG. 28 is a diagram illustrating a periodic shift in the column direction in a unit pixel from which a pixel signal is periodically read out in the second example of the third embodiment.

FIG. 29 is a block diagram illustrating a functional configuration example of a solid-state imaging device according to a fourth embodiment.

FIG. 30 is a block diagram illustrating a functional configuration example of a solid-state imaging device according to a fifth embodiment.

FIG. 31 is a flowchart illustrating a schematic operation example of an event number determination circuit according to the fifth embodiment.

FIG. 32 is a diagram illustrating an example of an enable signal having a high duty ratio according to the fifth embodiment.

FIG. 33 is a diagram illustrating an example of an enable signal having a low duty ratio according to the fifth embodiment.

FIG. 34 is a block diagram illustrating an example of a schematic configuration of a vehicle control system.

FIG. 35 is a diagram illustrating an example of installation positions of a vehicle exterior information detector and an imaging unit.

### DESCRIPTION OF EMBODIMENTS

An embodiment of the present disclosure will be described below in detail with reference to the drawings. In each of the following embodiments, the same parts are denoted by the same reference symbols, and a repetitive description thereof will be omitted.

The present disclosure will be described in the following order.

1. First Embodiment

1.1 Configuration example of imaging device

1.2 Example of solid-state imaging device

1.2.1 Schematic configuration example of solid-state imaging device

1.2.2 Configuration example of unit pixel

1.2.3 Basic operation example of solid-state imaging device

1.3 Configuration example of row/column signal generation circuit

1.4 Role of row/column OR circuit

1.5 Luminance image acquired by first embodiment

1.6 Action/effects

2. Second Embodiment

2.1 First example

2.2 Second example

2.3 Third example

3. Third Embodiment

3.1 First example

3.2 Second example

4. Fourth Embodiment

4.1 Functional configuration example of solid-state imaging device

4.2 Action/effects

5. Fifth Embodiment

5.1 Functional configuration example of solid-state imaging device

5.2 Operation example of event number determination circuit

5.3 Action/effects

6. Example of application to moving object

### 1. First Embodiment

First, a first embodiment will be described in detail with reference to the drawings.

### 1.1 Configuration Example of Imaging Device

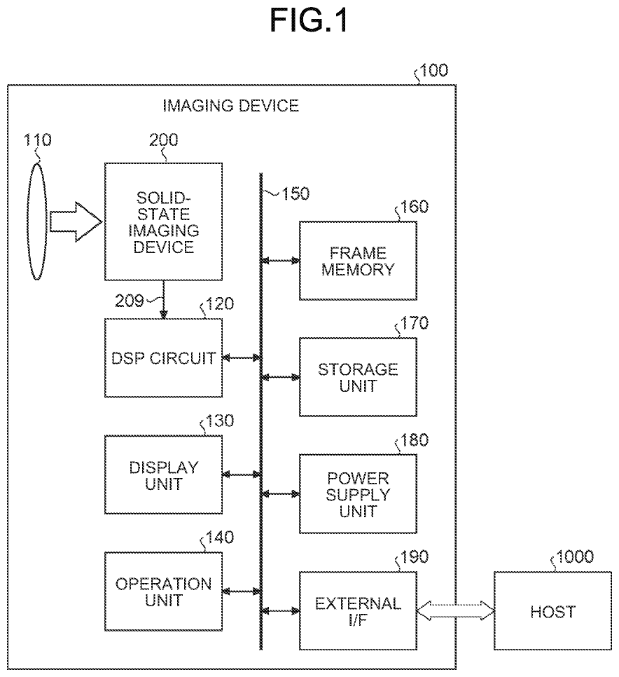

FIG. 1 is a block diagram illustrating a schematic configuration example of an imaging device according to the first embodiment. An imaging device 100 is a device for capturing a luminance image, for example, and includes an optical system 110, a solid-state imaging device 200, and a Digital Signal Processing (DSP) circuit 120 as illustrated in FIG. 1. The imaging device 100 further includes a display unit 130, an operation unit 140, a bus 150, frame memory 160, a storage unit 170, and a power supply unit 180. Examples of the imaging device 100 can include a digital camera such as a digital still camera, a smartphone or a personal computer having an imaging function, or an in-vehicle camera.

The optical system 110 collects light from a subject and guides the collected light to the solid-state imaging device 200. The solid-state imaging device 200 generates luminance information for each of pixels based on an electric charge generated by photoelectric conversion, for example. Furthermore, the solid-state imaging device 200 supplies the generated luminance information for each of the pixels to the DSP circuit 120 via a signal line 209.

The DSP circuit 120 executes predetermined signal processing on the luminance information from the solid-state imaging device 200. The DSP circuit 120 then outputs the processed luminance information to the frame memory 160 or the like via the bus 150.

The display unit 130 displays image data stored in the frame memory 160, for example. Example of the display unit 130 can include a liquid crystal panel or an organic Electro Luminescence (EL) panel. The operation unit 140 generates an operation signal according to user's operation.

The bus 150 is a common route for exchanging data between the optical system 110, the solid-state imaging device 200, the DSP circuit 120, the display unit 130, the operation unit 140, the frame memory 160, the storage unit 170, and the power supply unit 180.

The frame memory 160 holds image data. For example, luminance information for each of pixels acquired by the solid-state imaging device 200 is stored in an address in the frame memory 160 according to the arrangement of the pixels, whereby the image data is created in the frame memory 160.

The storage unit 170 stores various data such as a program and various set values needed for operating individual units of the imaging device 100. The power supply unit 180 supplies power to the solid-state imaging device 200, the DSP circuit 120, the display unit 130, or the like.

An external interface (I/F) 190 is, for example, a transmitter/receiver such as a Universal Serial Bus (USB) or Local Area Network (LAN) adapter, and transmits/receives data or the like to/from a host 1000 that is externally provided, or the like.

### 1.2 Example of Solid-State Imaging Device

Next, the solid-state imaging device 200 according to the first embodiment will be described in detail with reference to the drawings.

1.2.1 Schematic Configuration Example of Solid-State Imaging Device

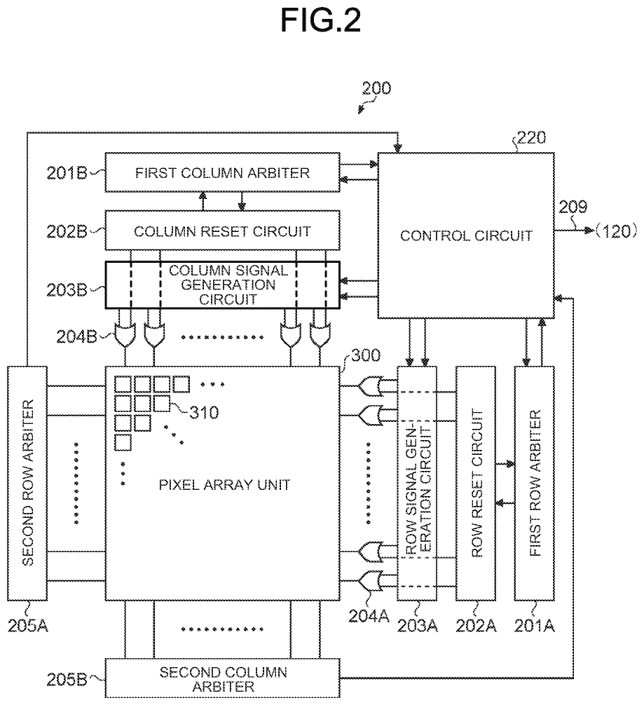

FIG. 2 is a block diagram illustrating a schematic configuration example of a solid-state imaging device according to the first embodiment. As illustrated in FIG. 2, the solid-state imaging device 200 includes a pixel array unit 300. The pixel array unit 300 has a plurality of unit pixels 310 arranged in a two-dimensional lattice or grid pattern (also referred to as a matrix pattern or in a matrix). In the following description, a set of unit pixels arranged in a predetermined direction (horizontal direction or left-right direction in the drawing) in the pixel array unit 300 is referred to as a “row”, and a set of unit pixels arranged in a direction perpendicular to the row (that is, vertical direction or top-bottom direction in the drawing) is referred to as a “column”.

Furthermore, the solid-state imaging device 200 includes a first row arbiter (first arbitration unit) 201A, a row reset circuit 202A, and a row signal generation circuit 203A arranged on one side in a row direction (horizontal direction or left-right direction in the drawing) with respect to the pixel array unit 300, and includes a second row arbiter (second arbitration unit) 205A arranged on the other side in the row direction.

Furthermore, the solid-state imaging device 200 includes a first column arbiter (first arbitration unit) 201B, a column reset circuit 202B, and a column signal generation circuit 203B arranged on one side in a column direction (vertical direction or top-bottom direction in the drawing) with respect to the pixel array unit 300, and includes a second column arbiter (second arbitration unit) 205B arranged on the other side in the column direction.

In the following description, when the first row arbiter 201A and the first column arbiter 201B are not distinguished from each other, they are collectively referred to as a first arbiter 201. Likewise, when the row reset circuit 202A and the column reset circuit 202B are not distinguished from each other, they are collectively referred to as a reset circuit 202. Furthermore, when the row signal generation circuit 203A and the column signal generation circuit 203B are not distinguished from each other, they are collectively referred to as a signal generation circuit 203. Still further, when the second row arbiter 205A and the second column arbiter 205B are not distinguished from each other, they are collectively referred to as a second arbiter 205.

The solid-state imaging device 200 further includes a control circuit 220 that generates address information indicating the position of the unit pixel 310 in which a firing of the address event is detected in the pixel array unit 300 and that generates a time stamp indicating the time when the firing of the address event is detected, based on the request signal input from the first arbiter 201 or the second arbiter 205. The control circuit 220 also generates a pixel value of the unit pixel 310 as a readout target based on the request signal input from the second arbiter 205.

Furthermore, the control circuit 220 inputs, into the row signal generation circuit 203A and the column signal generation circuit 203B, a signal in which ‘0’ and ‘1’ change in a predetermined period or randomly (hereinafter, referred to as a pattern signal) and an enable signal (including a row enable signal and a column enable signal described below). Note that a bit pattern of the pattern signal (hereinafter referred to as row pattern signal) input to the row signal generation circuit 203A and a bit pattern of the pattern signal (hereinafter referred to as column pattern signal) input to the column signal generation circuit 203B may be different from each other. In the following description, when the row pattern signal and the column pattern signal are not distinguished from each other, they are simply referred to as a pattern signal. This pattern signal may be an example of a second reset signal in the claims.

Furthermore, the solid-state imaging device 200 includes: a row logical sum (OR) circuit 204A that performs row-based logical sum operation of a row reset signal (for example, a signal of ‘0’ or ‘1’) output from the row reset circuit 202A and a row pattern signal output from the row signal generation circuit 203A; and a column logical sum (OR) circuit 204B that performs column-based logical sum operation of a column reset signal (for example, a signal of ‘0’ or ‘1’) output from the column reset circuit 202B and a column pattern signal output from the column signal generation circuit 203B. In the following description, when the row reset signal and the column reset signal are not distinguished from each other, they are simply referred to as a reset signal. This reset signal may be an example of a first reset signal in the claims.

1.2.2 Configuration Example of Unit Pixel

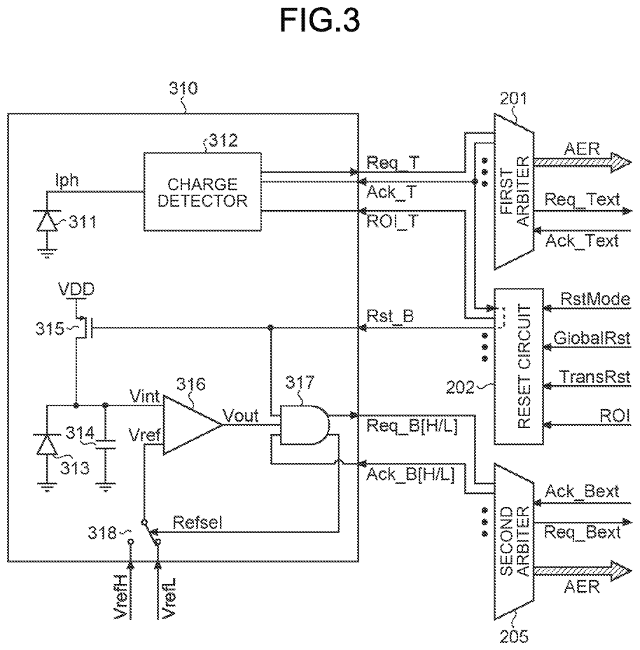

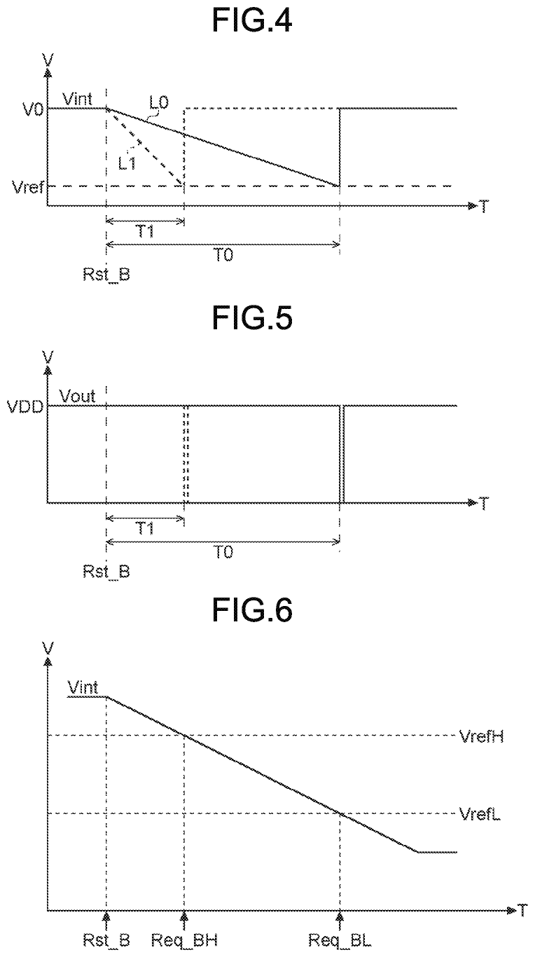

Here, a configuration example of the unit pixel 310 will be described. FIG. 3 is a circuit diagram illustrating a configuration example of the unit pixel according to the first embodiment. FIG. 4 is a waveform diagram illustrating the potential change of the capacitor in FIG. 3. FIG. 5 is a waveform diagram illustrating an output signal that is output from the comparator in FIG. 3. FIG. 6 is a diagram illustrating operations of the logic circuit in FIG. 3. In FIG. 3, for simplification, the first row arbiter 201A and the first column arbiter 201B are referred to as the first arbiter 201 with no distinction, the row reset circuit 202A and the column reset circuit 202B are referred to as the reset circuit 202 with no distinction, and the second row arbiter 205A and the second column arbiter 205B are referred to as the second arbiter 205 with no distinction.

As illustrated in FIG. 3, the unit pixel 310 includes a first photodiode 311 and a charge detector 312 as a configuration for detecting the presence or absence of firing of an address event. The first photodiode 311 may be a photoelectric conversion element that photoelectrically converts incident light to generate an electric charge.

Here, as described above, the address event includes an on-event and an off-event, and a detection result can include a 1-bit on-event detection result and a 1-bit off-event detection result.

An on-event fires when the amount of light received by the light receiving element of the unit pixel 310 has fluctuated to a value larger than a predetermined reference value and when the absolute value of the amount of fluctuation exceeds a predetermined threshold. In contrast, an off-event fires when the amount of light received by the light receiving element of the unit pixel 310 has fluctuated to a value smaller than a predetermined reference value and when the absolute value of the amount of fluctuation exceeds a predetermined threshold. In the following description, for simplification, on-events and off-events will be described without distinction.

The charge detector 312 detects the firing of an address event based on the electric charge generated in the first photodiode 311. When the firing of an address event is detected, a charge detector 322 transmits, to the first arbiter 201, a request signal Req_T to request for the reset of the electric charge stored in a capacitor 314 for generating the pixel value, which will be described below (hereinafter, simply referred to as the reset of the unit pixel 310).

When a response signal AcK_T to the request signal Req_T issued from the first arbiter 201 is input from the first arbiter 201, the charge detector 312 resets itself and starts monitoring the firing of the next address event.

When monitoring the firing of an address event only in a part of the pixel array unit 300, it is allowable to input to the charge detector 312, for example, a signal ROI_T indicating that its own unit pixel 310 belongs to the region as a monitoring target (region of interest), via the reset circuit 202.

Furthermore, the unit pixel 310 includes a second photodiode 313, a capacitor 314, a reset transistor 315, a comparator 316, a logic circuit 317, and a switch 318 as a configuration for generating a pixel value. The second photodiode 313 may be a photoelectric conversion element that photoelectrically converts incident light to generate an electric charge. Furthermore, the capacitor 314, the reset transistor 315, the comparator 316, the logic circuit 317, and the switch 318 may be an example of a generation circuit in the claims.

The capacitor 314 has one electrode (hereinafter referred to as a first electrode) connected to a cathode of the second photodiode 313 and has the other electrode (hereinafter referred to as a second electrode) being grounded.

When a reset signal Rst_B is input to the gate of the reset transistor 315 from the reset circuit 202, the reset transistor 315 accumulates a predetermined amount of electric charge in the capacitor 314 by connecting the first electrode of the capacitor 314 to a power supply voltage VDD (reset state). At that time, the electric charge accumulated in the second photodiode 313 may be discharged to the power supply voltage VDD.

Here, the change in the potential appearing at the first electrode of the capacitor 314 will be described with reference to FIG. 4. As illustrated in FIG. 4, in a state where the reset transistor 315 is turned on and the capacitor 314 is reset, a potential Vint having a reset level of V0 appears on the first electrode.

In this state, when light is incident on the second photodiode 313 to generate an electric charge, the electric charge accumulated in the capacitor 314 is discharged by the electric charge generated in the second photodiode 313. At that time, when the amount of light incident on the second photodiode 313 is small, the electric charge accumulated in the capacitor 314 is gently discharged, which gently decreases the potential Vint of the first electrode as illustrated in a waveform L0. The period required for the potential Vint to decrease from the reset level V0 to the reference voltage Vref when the amount of incident light is small is defined as a period T0.

In contrast, when the amount of light incident on the second photodiode 313 is large, the electric charge accumulated in the capacitor 314 is abruptly discharged, which abruptly decreases the potential Vint of the first electrode as illustrated in a waveform L1. That is, when the period required for the potential Vint to decrease from the reset level V0 to the reference voltage Vref when the amount of incident light is large is a period T1, the period T1 is shorter than the period T0.

Description will continue with reference back to FIG. 3. The comparator 316 compares the potential Vint of one electrode of the capacitor 314 with a reference voltage VrefH/VrefL input from the outside, and outputs, as a result, an output signal Vout of ‘0’ or ‘1’.

When this is described based on the waveform diagram illustrated in FIG. 4, as illustrated in FIG. 5, the comparator 316 outputs a high level (VDD level) output signal Vout over the period T0 when the amount of light incident on the second photodiode is small, while outputs a high level (VDD level) output signal Vout over the period T1 shorter than the period T0 when the amount of incident light on the second photodiode is large.

Description will continue with reference back to FIG. 3. The logic circuit 317 inputs the reset signal Rst_B from the reset circuit 202, the output signal Vout from the comparator 316, and the response signal Ack_B from the second arbiter 205, and then outputs a request signal Req_B[H/L] based on a result of logical operation of these inputs.

Furthermore, based on the result of the logical operation, the logic circuit 317 outputs, to the switch 318, a switching signal Refsel for switching the reference voltage to be input to the comparator 316 between a high voltage level reference voltage VrefH and a low voltage level reference voltage VrefL.

When this is described with reference to FIG. 6, for example, having received an input of the high level reset signal Rst_B, the logic circuit 317 outputs the switching signal Refsel that switches the switch 318 so that the reference voltage VrefH will be input to the comparator 316. Thereafter, when the potential Vint of the first electrode of the capacitor 314 becomes lower than the reference voltage VrefH and the output signal Vout from the comparator 316 has been switched from ‘1’ to ‘0’, the logic circuit 317 transmits a first request signal Req_BH to the second arbiter 205.

Furthermore, having received an input of the response signal Ack_BH for the first request signal Req_BH from the second arbiter 205, the logic circuit 317 outputs a switching signal Refsel that switches the switch 318 so that the reference voltage VrefL will be input to the comparator 316. This operation switches the reference voltage to be input to the comparator 316 from the reference voltage VrefH to the reference voltage VrefL, allowing the output signal that is output from the comparator 316 to rise from ‘0’ to ‘1’.

Thereafter, when the potential Vint of the first electrode becomes lower than the reference voltage VrefL and the output signal Vout from the comparator 316 is switched again from ‘1’ to ‘0’, the logic circuit 317 transmits a second request signal Req_BL to the second arbiter 205.

1.2.3 Basic Operation Example of Solid-State Imaging Device

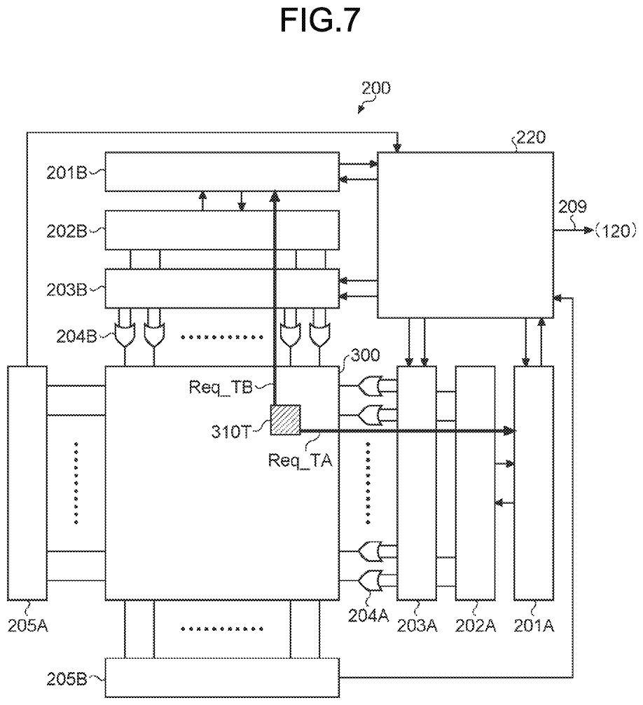

Next, operations of the solid-state imaging device 200 will be described. FIGS. 7 to 11 are diagrams illustrating an operation example of the solid-state imaging device according to the first embodiment.

When the unit pixel 310 has detected a firing of an address event, as illustrated in FIG. 7, the unit pixel 310 transmits a row request signal Req_TA requesting a reset for the unit pixel 310 to the first row arbiter 201A, and also transmits a column request signal Req_TB requesting a reset for the unit pixel 310 to the first column arbiter 201B. The row request signal Req_TA and the column request signal Req_TB correspond to the above-described request signal Req_T. In this description, when the row request signal Req_TA and the column request signal Req_TB are not distinguished from each other, they are simply referred to as a request signal Req_T.

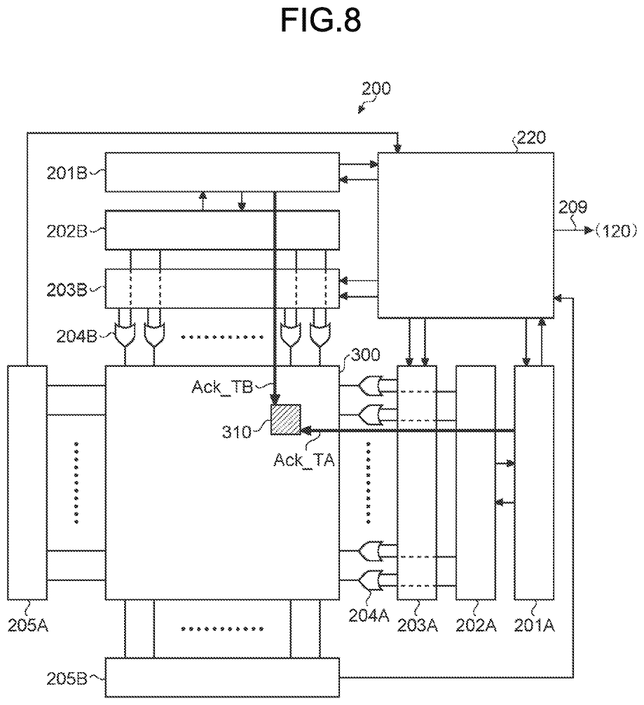

In response to this, as illustrated in FIG. 8, the first row arbiter 201A specifies a row address of the unit pixel 310 which is the source of the row request signal Req_TA, and makes an arbitration on the row request signals Req_TA input from one or more unit pixels 310. Subsequently, the first row arbiter 201A inputs a result of the arbitration to the row reset circuit 202A, and also transmits a row response signal Ack_TA to the unit pixel 310 which is the source of the row request signal Req_TA. Similarly, the first column arbiter 201B specifies a column address of the unit pixel 310 which is the source of the column request signal Req_TB, and makes an arbitration on the column request signals Req_TB input from one or more unit pixels 310. Subsequently, the first column arbiter 201B inputs a result of the arbitration to the column reset circuit 202B, and also transmits a column response signal Ack_TB to the unit pixel 310 which is the source of the column request signal Req_TB. The row response signal Ack_TA and the column response signal Ack_TB correspond to the response signal Ack_T described above, and in this description, when the row response signal Ack_TA and the column response signal Ack_TB are not distinguished from each other, they are simply referred to as a response signal Ack_T.

Furthermore, the first row arbiter 201A and the first column arbiter 201B input, to the control circuit 220, the address information (row address and column address) of the unit pixel 310 in which the firing of the address event has been detected. The control circuit 220 generates a time stamp indicating the time when the address information is input from the first row arbiter 201A and the first column arbiter 201B, and then outputs the address information and the time stamp to the DSP circuit 120 as an event detection signal.

The output event detection signal may undergo predetermined processing in the DSP circuit 120 and then may be stored in the frame memory 160 or transmitted to the host 1000 via the external I/F 190.

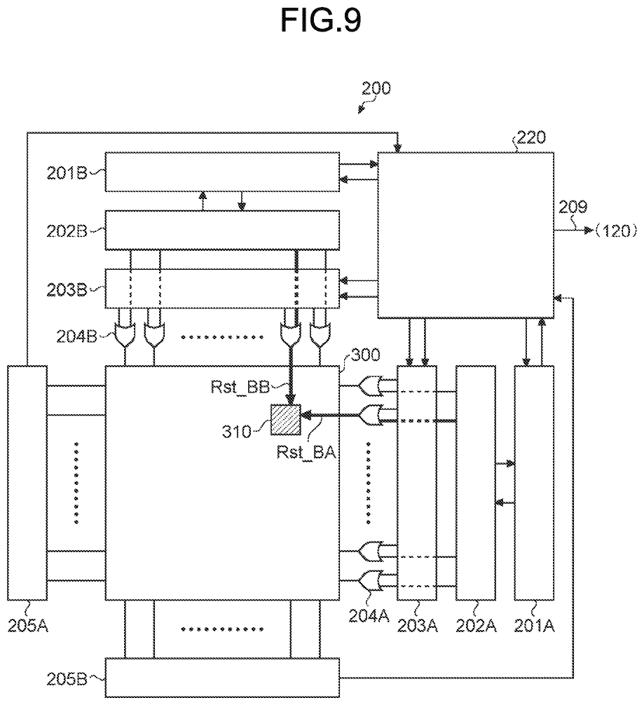

Next, as illustrated in FIG. 9, the row reset circuit 202A outputs a row reset signal Rst_BA to the unit pixel 310 in which the firing of the address event is detected, based on the arbitration result input from the first row arbiter 201A. Similarly, the column reset circuit 202B outputs a column reset signal Rst_BB to the unit pixel 310 in which the firing of the address event is detected, based on the arbitration result input from the first column arbiter 201B. With this configuration, the unit pixels 310 in which the firing of the address event is detected will be reset in order. The row reset signal Rst_BA and the column reset signal Rst_BB correspond to the above-described reset signal Rst_B. In this description, when the row reset signal Rst_BA and the column reset signal Rst_BB are not distinguished from each other, they are simply referred to as a reset signal Rst_B.

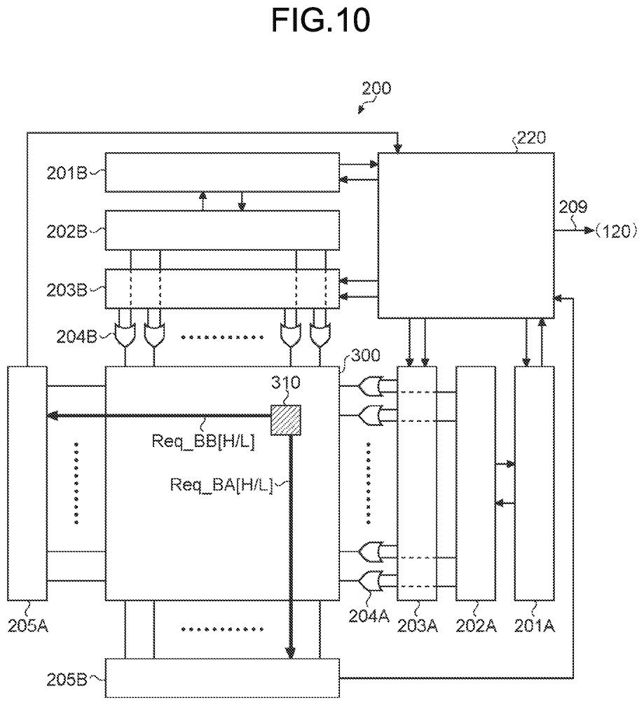

When the potential Vint of the first electrode of the capacitor 314 drops below the reference voltage VrefH due to the exposure to the second photodiode 313 in the unit pixel 310 in which the capacitor 314 has been reset, the unit pixel 310 transmits the row request signal Req_BAH to the second row arbiter 205A, and transmits the column request signal Req_BBH to the second column arbiter 205B as illustrated in FIG. 10. The row request signal Req_BAH and the column request signal Req_BBH correspond to the above-described request signal Req_BH. In this description, when the row request signal Req_BAH and the column request signal Req_BBH are not distinguished from each other, they are simply referred to as a request signal Req_BH.

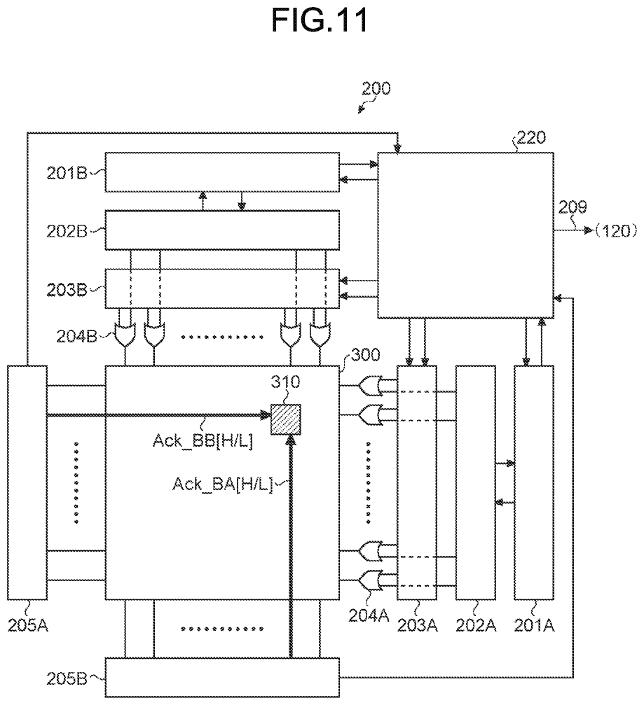

In response to this, as illustrated in FIG. 11, the second row arbiter 205A specifies the row address of the unit pixel 310 which is the source of the row request signal Req_BAH, inputs the specified row address to the control circuit 220, and transmits the specified row response signal Ack_BAH to the unit pixel 310. Similarly, the second column arbiter 205B specifies the column address of the unit pixel 310 which is the source of the column request signal Req_BBH, inputs the specified column address to the control circuit 220, and transmits the specified row response signal Ack_BBH to the unit pixel 310. The row response signal Ack_BAH and the column response signal Ack_BBH correspond to the response signal Ack_BH described above. In this description, when the row response signal Ack_BAH and the column response signal Ack_BBH are not distinguished from each other, they are simply referred to as a response signal Ack_BH.

After the unit pixel 310 receives the row response signal Ack_BAH and the column response signal Ack_BBH and when the potential Vint of the first electrode of the capacitor 314 becomes lower than the reference voltage VrefL due to the continuous exposure to the second photodiode 313, the unit pixel 310 transmits the row request signal Req_BAL to the second row arbiter 205A, and transmits the column request signal Req_BBL to the second column arbiter 205B again as illustrated in FIG. 10. The row request signal Req_BAL and the column request signal Req_BBL correspond to the above-described request signal Req_BL. In this description, when the row request signal Req_BAL and the column request signal Req_BBL are not distinguished from each other, they are simply referred to as a request signal Req_BHL.

When the row request signals Req_BAH and Req_BAL and the column request signals Req_BBH and Req_BBL have been input as described above, the control circuit 220 generates a time stamp indicating the time of input of each of the signals. Subsequently, based on the time stamp generated as above, the control circuit 220 specifies a time difference from the timing when the row request signal Req_BAH and the column request signal Req_BBH are input, to the timing when the row request signal Req_BAL and the column request signal Req_BBL are input, and then generates a pixel value of the unit pixel 310 based on the specified time difference. Subsequently, the generated pixel value is output to the DSP circuit 120 as a pixel signal. In the following description, “generating a pixel value for a unit pixel 310 and outputting the value as a pixel signal” is referred to as “reading out a pixel signal from the unit pixel 310”.

The read out pixel signal may undergo predetermined processing in the DSP circuit 120 and then may be stored in the frame memory 160 or transmitted to the host 1000 via the external I/F 190.

### 1.3 Configuration Example of Row/Column Signal Generation Circuit

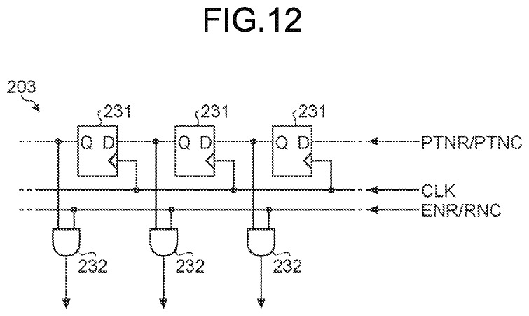

FIG. 12 is a circuit diagram illustrating a schematic configuration example of a row signal generation circuit/column signal generation circuit according to the first embodiment. The row signal generation circuit 203A and the column signal generation circuit 203B may have a similar circuit configuration.

As illustrated in FIG. 12, the signal generation circuit 203 includes: a plurality of D-type flip-flops (hereinafter, simply referred to as flip-flops) 231 as shift registers provided for each of rows or columns; and a plurality of logical product (AND) circuits 232 provided for each of rows or columns in the same manner.

The plurality of flip-flops 231 are connected in multiple stages so that an output Q of the flip-flop 231 in the previous stage is to be input to an input D of the flip-flop 231 in the subsequent stage.

The input D of the flip-flop 231 arranged in the first stage receives an input of a row pattern signal PTNR or a column pattern signal PTNC bit by bit from the control circuit 220.

Furthermore, a clock CLK output from the control circuit 220 or another circuit at a predetermined cycle is input to a clock terminal of each of the flip-flops 231.

The flip-flop 231 in each of stages allows one bit of signal, that is, the row pattern signal PTNR or the column pattern signal PTNC input to the input D from the control circuit 220 or the flip-flop 231 in the previous stage, to be output from the output Q in synchronization with the clock CLK so as to be input to the input D of the flip-flop 231 in the subsequent stage. Therefore, the row pattern signal PTNR or the column pattern signal PTNC input to the input D of the first-stage flip-flop 231 is sequentially input to the input D of the subsequent-stage flip-flop 231 in one clock cycle.

Incidentally, the output Q of the flip-flop 231 in the final stage may be connected to the input D of the flip-flop 231 in the first stage, for example. In that case, after inputting a row pattern signal PTNR or a column pattern signal PTNC having a certain bit number, the row pattern signal PTNR and the column pattern signal PTNC may circulate in the row signal generation circuit 203A or the column signal generation circuit 203B, respectively.

Furthermore, the output of the flip-flop 231 in each of stages is also input to one input of the AND circuit 232 provided for each of rows or columns. The other input of the AND circuit 232 receives an input of a row enable signal ENR or a column enable signal ENC supplied from the control circuit 220. Therefore, each of the AND circuits 232 outputs the row pattern signal PTNR or the column pattern signal PTNC output from the output Q of the flip-flop 231 of each of stages to the row OR circuit 204A or the column OR circuit 204B during the period when the row enable signal or the column enable signal is at a high level (for example, ‘1’).

### 1.4 Role of Row/Column OR Circuit

The row OR circuit 204A provided for each of rows performs logical sum operation of the row reset signal Rst_BA output from the row reset circuit 202A and the row pattern signal PTNR output from the row signal generation circuit 203A, and then outputs a result of the operation, as the row reset signal Rst_BA, to the unit pixel 310 which is the source of the row request signal Req_TA. Similarly, the column OR circuit 204B provided for each of columns performs logical sum operation of the column reset signal Rst_BB output from the column reset circuit 202B and the column pattern signal PTNC output from the column signal generation circuit 203B, and then outputs a result of the operation, as the row reset signal Rst_BB, to the unit pixel 310 which is the source of the column request signal Req_TB.

In this manner, by supplying the pseudo reset signal Rst_B based on the pattern signal PTN even for the unit pixel 310 in which the firing of the address event has not been detected, it is possible to read out the reset and pixel signals for a certain unit pixel 310.

In the following description, when the row OR circuit 204A and the column OR circuit 204B are not distinguished from each other, they are simply referred to as an OR circuit 204. Furthermore, the reset circuit 202, the signal generation circuit 203, and the OR circuit 204 in the present embodiment may be an example of a reset controller in the claims.

### 1.5 Luminance Image Acquired by First Embodiment

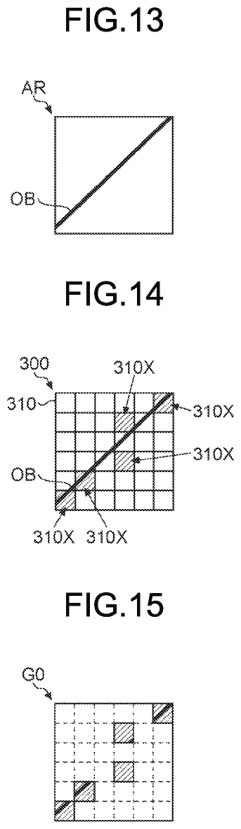

Next, a luminance image acquired by the present embodiment described above will be described in detail with reference to the drawings below. The present description presents a case, as illustrated in FIG. 13, where a rod-shaped object OB passes through an angle of view AR of the pixel array unit 300. In addition, the present description uses, for simplification, a configuration of the pixel array unit 300 including a total of 36 (6×6 pixels) unit pixels 310, in which image data (luminance image) of 6×6 pixels is created in the frame memory 160. In addition, the image data may be formed in the host 1000 instead of the frame memory 160.

When the background and the object OB have similar colors when the object OB passes through the angle of view AR of the pixel array unit 300, for example, there is a possibility, as illustrated in FIG. 14, of having a case where only a partial unit pixel, that is, a unit pixel 310X out of the unit pixel 310 corresponding to the object OB in the angle of view AR detects a firing of an address event, while the other unit pixels 310 do not detect the firing of the address event.

Such a case, as illustrated in FIG. 15, would lead to occurrence of irregular hole-like missing pixels out of the pixels corresponding to the object OB in image data G0 formed with the pixel signals output from the solid-state imaging device 200 according to the firing of the address event.

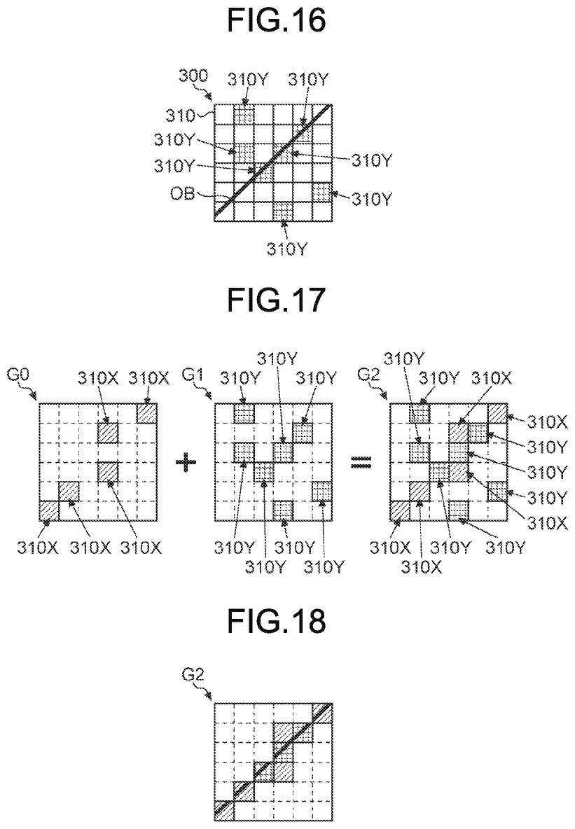

To handle this issue, in the present embodiment, as illustrated in FIG. 16, a pixel signal is periodically read out from one or more arbitrary unit pixels 310Y in a fixed readout cycle described below. Subsequently, as illustrated in FIG. 17, the image data G0 acquired based on the firing of the address event and image data G1 formed with the periodically read out pixel signals are superposed in the frame memory 160, for example, so as to create image data G2 in which the image data G0 and the image data G1 are integrated to each other in the frame memory 160. Incidentally, the one or more arbitrary unit pixels 310Y to be read out periodically are the unit pixels 310 specified by the row pattern signal PTNR and the column pattern signal PTNC described above.

The above superposition can interpolate the missing portions of the pixels corresponding to the object OB in the image data G0 by the image data G1, making it possible to create the image data G2 that has high image quality and accurately image the object OB, as illustrated in FIG. 18.

The image data G0 may be, for example, image data formed with pixel signals read out from the solid-state imaging device 200 within a certain cycle (event aggregation cycle). In the present description, the cycle for generating one image data G0 is referred to as an event aggregation cycle, and the cycle for reading out the pixel signal from the unit pixel 310Y is referred to as a fixed readout cycle.

Furthermore, the image data G1 to be integrated with the image data G0 is not limited to one, and may be provided in plurality. That is, by periodically reading out the pixel signals from a plurality of unit pixels 310Y over a plurality of times within a certain event aggregation cycle, and superposing a plurality of pieces of image data G1 formed with pixel signals read out in each fixed readout cycle with the image data G0, it is also possible to generate the image data G2 with higher image quality.

### 1.6 Action/Effects

As described above, the present embodiment makes it possible to interpolate the missing portions in the image data G0 generated based on the firing of the address event by using the image data G1 periodically read out, leading to generation of the image data G2 with high image quality.

### 2. Second Embodiment

The first embodiment has described a case where the unit pixel 310Y which periodically reads out the pixel signal regardless of the firing of the address event (hereinafter referred to as the unit pixel as a periodic readout target) is specified by using a pattern signal in which ‘0’ and ‘1’ changes by a predetermined period or changes randomly. In contrast, in a second embodiment, a case where the unit pixel 310Y as a periodic readout target is fixed will be described with an example.

The imaging device 100 and the solid-state imaging device 200 according to the present embodiment may be similar to those according to the first embodiment. In addition, the following description uses, for simplification, a configuration of the pixel array unit 300 including a total of 36 (6×6 pixels) unit pixels 310, in which image data (luminance image) of 6×6 pixels is generated in the frame memory 160 or the host 1000. Furthermore, in the present embodiment, detailed description of the configurations, operations and effects similar to those in the above-described embodiment will be omitted by quoting them.

### 2.1 First Example

First, a case where the unit pixel 310Y as a periodic readout target is fixed in column units will be described with an example.

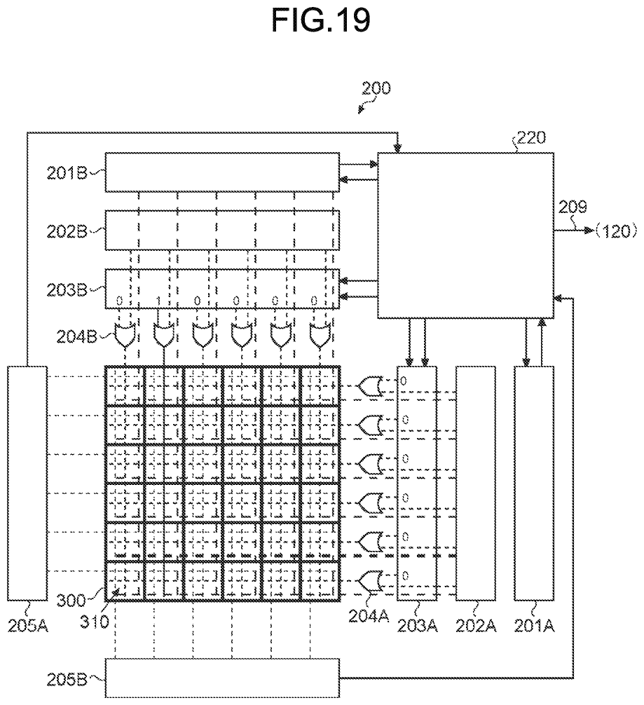

FIG. 19 is a schematic diagram illustrating an example of a column pattern signal held in a column signal generation circuit in a first example. As illustrated in FIG. 19, when the unit pixel 310Y as a periodic readout target is fixed in column units, the column signal generation circuit 203B has an input of a column enable signal ENC during the period in which each of the flip-flops 231 outputs a specific column pattern signal PTNC.

Specifically, as illustrated in FIG. 19, when the second column from the left is a column of the unit pixels 310 from which pixel signals are periodically read out, the column enable signal ENC is input to the column signal generation circuit 203B when each of the flip-flops 231 in the column signal generation circuit 203B is in a state of holding ‘0’, ‘1’, ‘0’, ‘0’, ‘0’, and ‘0’ in order from the left.

The row pattern signal PTNR held in each of the flip-flops 231 of the row signal generation circuit 203A when the column enable signal ENC is input to the column signal generation circuit 203B may be all ‘1’, may be a bit string having ‘0’ and ‘1’ arranged in a predetermined bit pattern, or a bit string having ‘0’ and ‘1’ arranged randomly.

The row enable signal ENR is also input to the row signal generation circuit 203A concurrently with input of the column enable signal ENC to the column signal generation circuit 203B, thereby specifying the unit pixel 310Y as a periodic readout target.

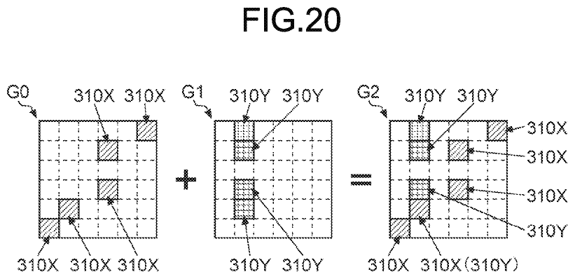

In this manner, even when the unit pixel 310Y as a periodic readout target is fixed in column units, it is also possible, as illustrated in FIG. 20, to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

### 2.2 Second Example

Next, a case where the unit pixel 310Y as a periodic readout target is fixed in row units will be described with an example.

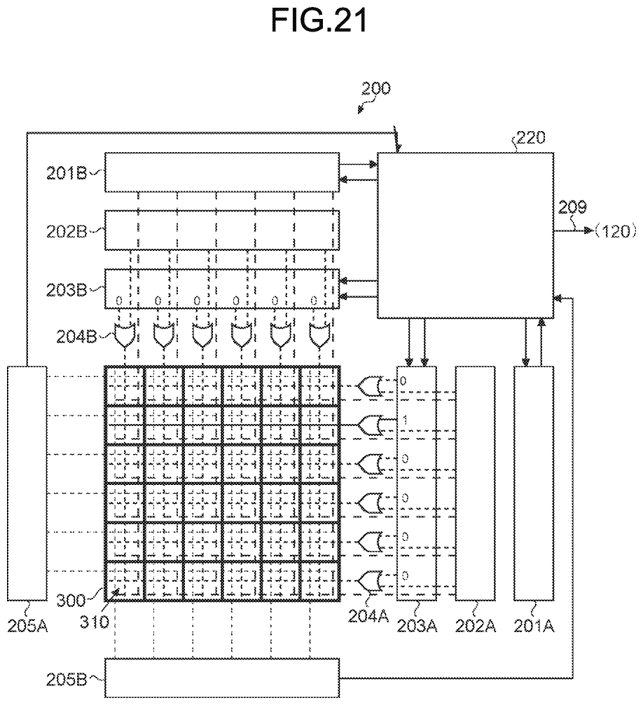

FIG. 21 is a schematic diagram illustrating an example of a row pattern signal held in a row signal generation circuit in a second example. As illustrated in FIG. 21, when the unit pixel 310Y as a periodic readout target is fixed in row units, the row signal generation circuit 203A has an input of row enable signal ENR during the period in which each of the flip-flops 231 outputs a specific row pattern signal PTNR.

Specifically, as illustrated in FIG. 21, when the second row from the top is a row of unit pixels 310 from which pixel signals are periodically read out, the row enable signal ENR is input to the row signal generation circuit 203A when each of the flip-flops 231 in the row signal generation circuit 203A is in a state holding ‘0’, ‘1’, ‘0’, ‘0’, ‘0’, and ‘0’ in order from the top.

The column pattern signal PTNC held in each of the flip-flops 231 of the column signal generation circuit 203B when the row enable signal ENR is input to the row signal generation circuit 203A may be all ‘1’, may be a bit string having ‘0’ and ‘1’ arranged in a predetermined bit pattern, or a bit string having ‘0’ and ‘1’ arranged randomly.

The column enable signal ENC is also input to the column signal generation circuit 203B concurrently with input of the row enable signal ENR to the row signal generation circuit 203A, thereby specifying the unit pixel 310Y as a periodic readout target.

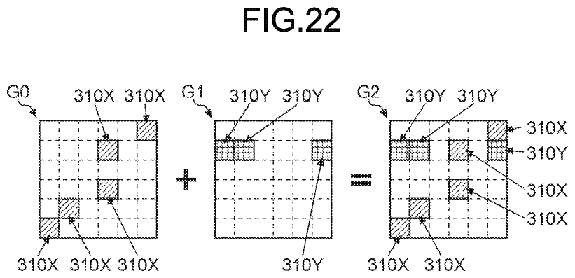

In this manner, even when the unit pixel 310Y as a periodic readout target is fixed in row units, it is also possible, as illustrated in FIG. 22, to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

### 2.3 Third Example

In the first and second examples described above, a case where the unit pixel 310Y as a periodic readout target is fixed in row units or column units will be described with specific examples. In contrast, in the third example, a case where the unit pixel 310Y as a periodic readout target is fixed in a region including a specific unit pixel 310 or one or more unit pixels 310 will be described with a specific example.

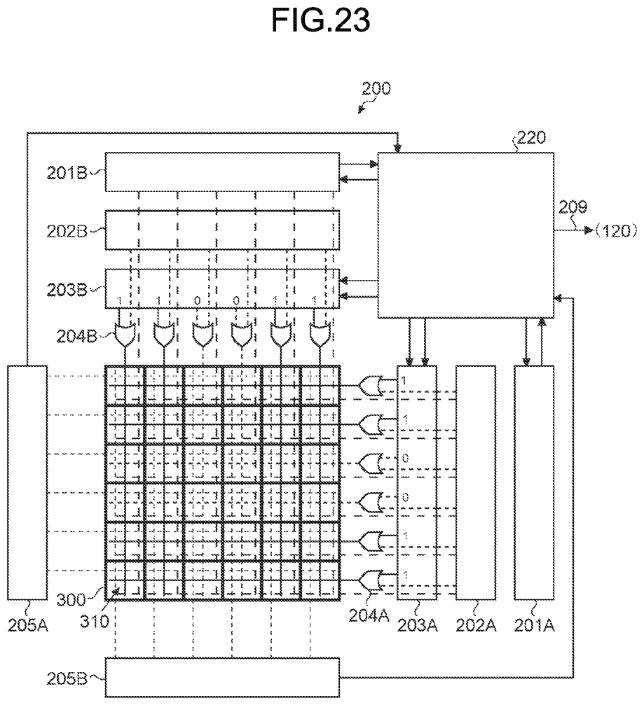

FIG. 23 is a schematic diagram illustrating an example of a row pattern signal held in a row signal generation circuit 203A and a column pattern signal held in a column signal generation circuit in the third example. In FIG. 23, the third example is illustrated as a case where the unit pixel 310 of 2×2 pixels in the upper left corner and the unit pixel 310 of 2×2 pixels in the lower right corner of the unit pixels 310, which are arranged on a matrix in the pixel array unit 300, are determined as the unit pixel 310Y as a periodic readout target.

As illustrated in FIG. 23, when the unit pixel 310Y as a periodic readout target is fixed in a region including a specific unit pixel 310 or one or more unit pixels 310, the row enable signal ENR is input during the period in which each of the flip-flops 231 is outputting a specific row pattern signal PTNR to the row signal generation circuit 203A, and the column enable signal ENC is input during the period in which each of the flip-flops 231 are outputting a specific column pattern signal PTNC to the column signal generation circuit 203B.

Specifically, as illustrated in FIG. 23, the row enable signal ENR is input to the row signal generation circuit 203A, and the column enable signal ENC is input to the column signal generation circuit 203B, in a state where each of the flip-flops 231 in the row signal generation circuit 203A is holding ‘1’, ‘1’, ‘0’, ‘0’, ‘1’, ‘1’ in order from the top and where each of the flip-flops 231 in the column signal generation circuit 203B is holding ‘1’, ‘1’, ‘0’, ‘0’, ‘1’, and ‘1’ in order from the left. This operation will specify the unit pixel 310Y as a periodic readout target.

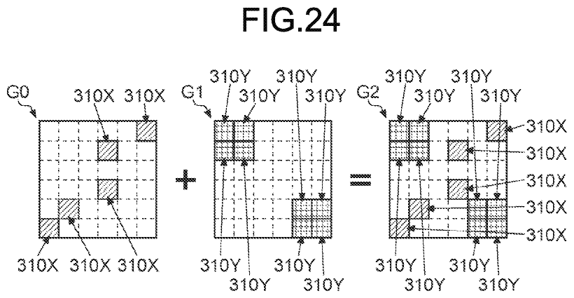

In this manner, even when the unit pixel 310Y as a periodic readout target is fixed in a region including a specific unit pixel 310 or one or more unit pixels 310, it is also possible, as illustrated in FIG. 24, to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

### 3. Third Embodiment

The second embodiment has illustrated a case where the unit pixel 310Y as a periodic readout target is fixed in column units, row units, or region units. In contrast, a third embodiment will describe a case where the unit pixel 310Y as a periodic readout target is changed periodically (this is referred to as a change cycle) using an example.

The imaging device 100 and the solid-state imaging device 200 according to the present embodiment may be similar to those according to the first embodiment. In addition, the following description uses, for simplification, a configuration of the pixel array unit 300 including a total of 36 (6×6 pixels) unit pixels 310, in which image data (luminance image) of 6×6 pixels is generated in the frame memory 160 or the host 1000. Furthermore, in the present embodiment, detailed description of the configurations, operations and effects similar to those in the above-described embodiment will be omitted by quoting them.

### 3.1 First Example

First, a case where the unit pixel 310Y as a periodic readout target is periodically shifted in the row direction at a predetermined change cycle will be described with an example.

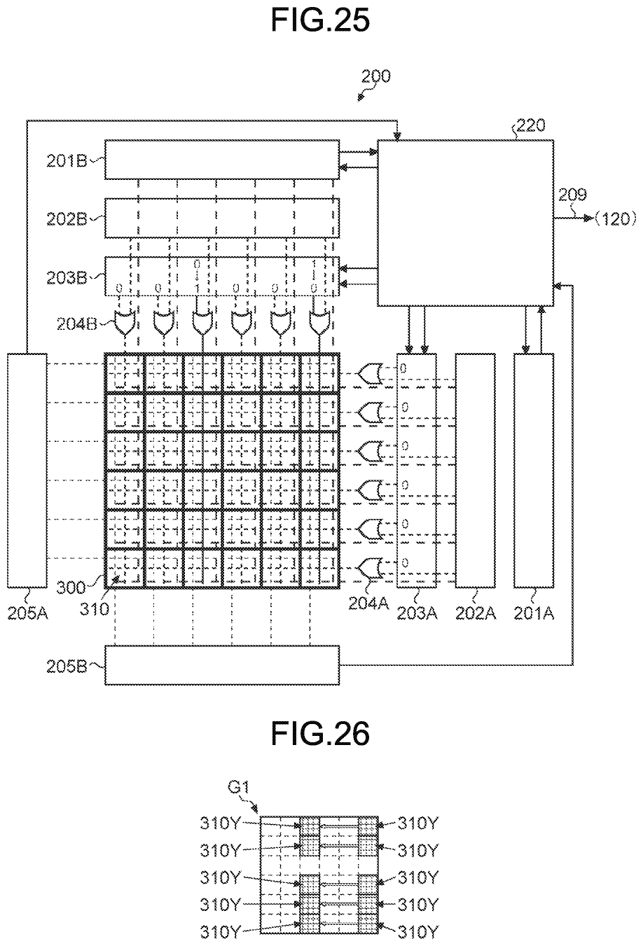

FIG. 25 is a schematic diagram illustrating an example of a column pattern signal held in a column signal generation circuit in a first example. As illustrated in FIG. 25, there is an exemplary case where the unit pixel 310Y as a periodic readout target is periodically shifted in the row direction by three columns. In this case, when the column pattern signal PTNC held by each of flip-flops 231 of the column signal generation circuit 203B in a certain period is ‘0’, ‘0’, ‘0’, ‘0’, ‘0’, and ‘1’ in order from the left, the column pattern signal PTNC held by each of flip-flops 231 of the column signal generation circuit 203B in the next period is ‘0’, ‘0’, ‘1’, ‘0’, ‘0’, and ‘0’ in order from the left.

In that case, for example, when it is assumed that the readout cycle of the pixel signal from an unit pixel 130Y is a cycle of three clocks CLK, the column enable signal ENC is to be input to the column signal generation circuit 203B every three clocks CLK. With this configuration, every time the column pattern signal PTNC of ‘1’ shifts to the left by three columns, the column enable signal ENC is to be input to the column signal generation circuit 203B, making it possible to periodically shift the unit pixel 310Y as a periodic readout target by three columns in the row direction, as illustrated in FIG. 26.

The row pattern signal PTNR held in each of the flip-flops 231 of the row signal generation circuit 203A when the column enable signal ENC is input to the column signal generation circuit 203B may be all ‘1’, may be a bit string having ‘0’ and ‘1’ arranged in a predetermined bit pattern, or a bit string having ‘0’ and ‘1’ arranged randomly.

The row enable signal ENR is also input to the row signal generation circuit 203A concurrently with input of the column enable signal ENC to the column signal generation circuit 203B, thereby specifying the unit pixel 310Y as a periodic readout target.

In this manner, even when the unit pixel 310Y as a periodic readout target is periodically shifted in the row direction, it is also possible to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

In addition, the pixels constituting the image data G1 acquired periodically are different every time. Accordingly, by using a plurality of pieces of image data G1 to be integrated with the image data G0, it is possible to interpolate more missing portions in the image data G0. This makes it possible to generate the image data G2 with higher image quality.

### 3.2 Second Example

Next, a case where the unit pixel 310Y as a periodic readout target is periodically shifted in the column direction at a predetermined change cycle will be described with an example.

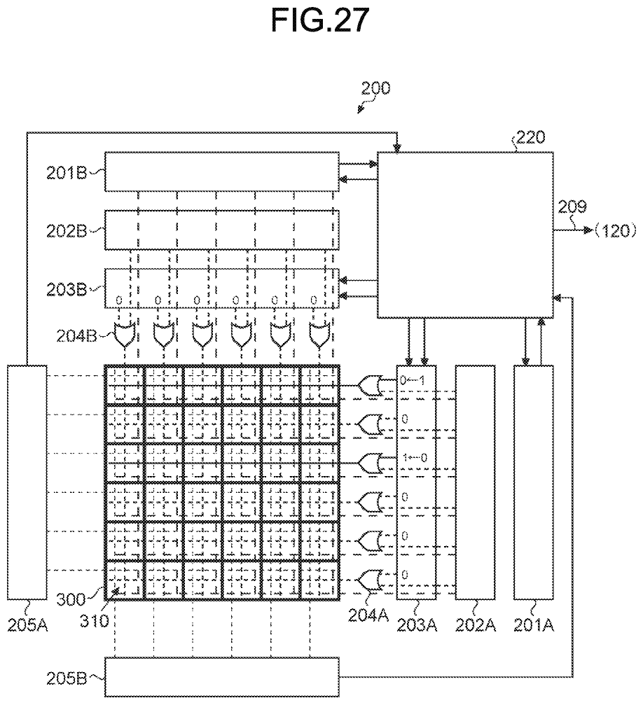

FIG. 27 is a schematic diagram illustrating an example of a row pattern signal held in a row signal generation circuit in a second example. As illustrated in FIG. 27, there is an exemplary case where the unit pixel 310Y as a periodic readout target is periodically shifted in the column direction by two rows. In this case, when the row pattern signal PTNR held by each of flip-flops 231 of the row signal generation circuit 203A in a certain period is ‘0’, ‘1’, ‘0’, ‘0’, ‘0’, and ‘0’ in order from the top, the row pattern signal PTNR held by each of flip-flops 231 of the row signal generation circuit 203A in the next period is ‘0’, ‘0’, ‘0’, ‘1’, ‘0’, and ‘0’ in order from the top.

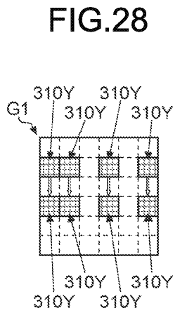

In that case, for example, when it is assumed that the readout cycle of the pixel signal from the unit pixel 130Y is a cycle of two clocks CLK, the row enable signal ENR is to be input to the row signal generation circuit 203A every two clocks CLK. With this configuration, every time the row pattern signal PTNR of ‘1’ shifts to the bottom by two rows, the row enable signal ENR is to be input to the row signal generation circuit 203A, making it possible to periodically shift the unit pixel 310Y as a periodic readout target by two rows in the column direction, as illustrated in FIG. 28.

The column pattern signal PTNC held in each of the flip-flops 231 of the column signal generation circuit 203B when the row enable signal ENR is input to the row signal generation circuit 203A may be all ‘1’, may be a bit string having ‘0’ and ‘1’ arranged in a predetermined bit pattern, or a bit string having ‘0’ and ‘1’ arranged randomly.

The column enable signal ENC is also input to the column signal generation circuit 203B concurrently with input of the row enable signal ENR to the row signal generation circuit 203A, thereby specifying the unit pixel 310Y as a periodic readout target.

In this manner, even when the unit pixel 310Y as a periodic readout target is periodically shifted in the column direction, it is also possible to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

In addition, the pixels constituting the image data G1 acquired periodically are different every time. Accordingly, by using a plurality of pieces of image data G1 to be integrated with the image data G0, it is possible to interpolate more missing portions in the image data G0. This makes it possible to generate the image data G2 with higher image quality.

### 4. Fourth Embodiment

The fourth embodiment will describe a case where a pattern signal is generated by using a pseudo-random number generator using an example. In the present embodiment, detailed description of the configurations, operations and effects similar to those in the above-described embodiment will be omitted by quoting them.

### 4.1 Functional Configuration Example of Solid-State Imaging Device

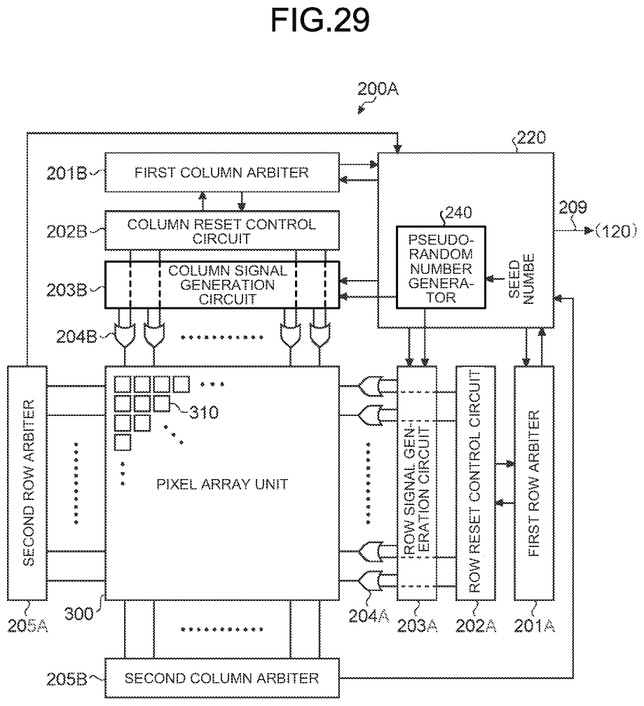

FIG. 29 is a block diagram illustrating a functional configuration example of a solid-state imaging device according to a fourth embodiment. As illustrated in FIG. 29, a solid-state imaging device 200A has a configuration similar to the configuration of the solid-state imaging device 200 described with reference to FIG. 3 or the like in the first embodiment, except that the control circuit 220 includes a pseudo-random number generator 240.

The pseudo-random number generator 240 is, for example, a digital circuit including a linear feedback shift register (LFSR) or the like, and generates a pseudo-random number by using a seed.

The pseudo-random number generator 240 internally holds a seed table listing a plurality of seeds, for example, and generates a pseudo-random number using the seed corresponding to the seed number input from the outside. The seed number may be specified randomly or in round-robin scheduling from the pseudo-random number generator 240 or the control circuit 220, or externally from the DSP circuit 120 or the host 1000. Alternatively, the pseudo-random number generator 240 does not have to include a seed table, and the seed may be input to the pseudo-random number generator 240 from the outside, such as the DSP circuit 120 or the host 1000.

The pseudo-random number generator 240 may change the seed used for each fixed readout cycle, or may change the seed used for each of a plurality of fixed readout cycles.

### 4.2 Action/Effects

As described above, even when the unit pixel 310Y as a periodic readout target is randomly changed, it is also possible to interpolate the missing portions in the image data G0 by using the image data G1 by allowing the image data G0 acquired based on the firing of the address event (refer to FIG. 17, for example) and the periodically acquired image data G1 to be superposed with each other in the frame memory 160 or the host 1000. This makes it possible to generate image data G2 with high image quality.

In addition, the pixels constituting the image data G1 acquired periodically are different every time. Accordingly, by using a plurality of pieces of image data G1 to be integrated with the image data G0, it is possible to interpolate more missing portions in the image data G0. This makes it possible to generate the image data G2 with higher image quality.

Since other configurations, operations, and effects may be similar to those in the above-described embodiment, detailed description thereof will be omitted here.

### 5. Fifth Embodiment

The above-described embodiments have illustrated exemplary cases where the pixel signal is periodically read out from the unit pixel 310Y regardless of the number of times of firing of the address event per unit time. However, for example, when the firing of an address event per unit time occurs a large number of times, frequently execution of periodic readout from the unit pixel 310Y would increase the amount of data processing, leading to a concern of occurrence of omission of detection of the address events.

Therefore, in the fifth embodiment, a case where the readout cycle for the unit pixel 310Y is changed according to the number of times of firings of the address event per unit time will be described with an example. In the present embodiment, detailed description of the configurations, operations and effects similar to those in the above-described embodiment will be omitted by quoting them. Furthermore, although the present embodiment illustrates a case based on the fourth embodiment, the embodiment used as a basis is not limited to the fourth embodiment and other embodiments can be used.

### 5.1 Functional Configuration Example of Solid-State Imaging Device

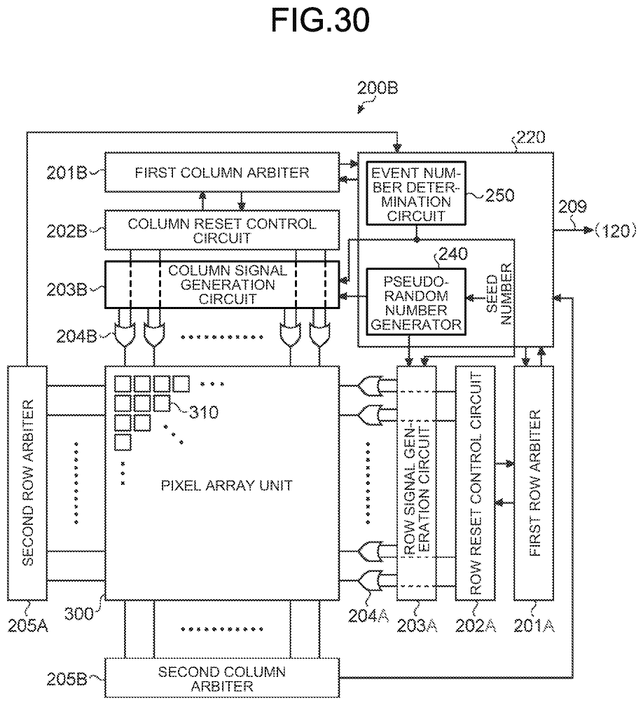

FIG. 30 is a block diagram illustrating a functional configuration example of a solid-state imaging device according to a fifth embodiment. As illustrated in FIG. 30, a solid-state imaging device 200B has a configuration similar to the configuration of the solid-state imaging device 200A described with reference to FIG. 29 in the fourth embodiment, except that the control circuit 220 includes an event number determination circuit 250.

In the present embodiment, the first row arbiter 201A and the first column arbiter 201B respectively input the row request signal Req_TA and the column request signal Req_TB to the event number determination circuit 250. The event number determination circuit 250 counts the number of address events (hereinafter referred to as the actual event number) fired per unit time (for example, one event aggregation cycle) based on the input row request signal Req_TA and column request signal Req_TB, for example, and changes the duty ratio of the row enable signal ENR and/or the column enable signal ENC to be input to the row signal generation circuit 203A and/or the column signal generation circuit 203B, based on the counted actual event number.

### 5.2 Operation Example of Event Number Determination Circuit

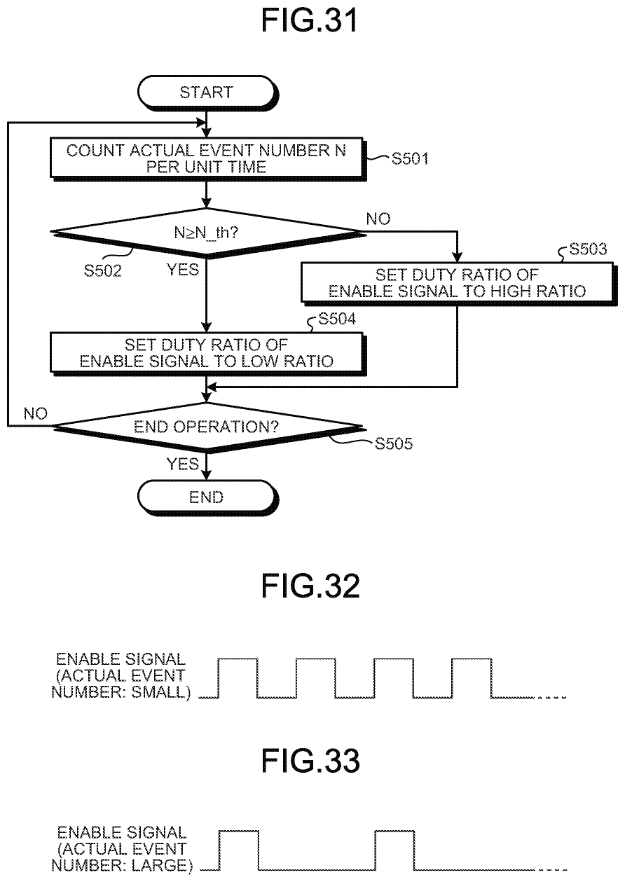

Next, an operation example of the event number determination circuit 250 according to the present embodiment will be described. FIG. 31 is a flowchart illustrating a schematic operation example of an event number determination circuit according to the fifth embodiment. As illustrated in FIG. 31, the event number determination circuit 250 counts the actual event number N per unit time based on the row request signal Req_TA and the column request signal Req_TB respectively input from the first row arbiter 201A and the first column arbiter 201B (step S501).

Next, the event number determination circuit 250 compares the actual event number N per unit time with a preset threshold N_th, for example (step S502). When the actual event number N is less than the threshold N_th (NO in step S502), the event number determination circuit 250 sets a high duty ratio for the duty ratio of the row enable signal ENR and/or the column enable signal ENC (step S503), and proceeds to step S505. For example, as illustrated in FIG. 32, the duty ratio of the row enable signal ENR and/or the column enable signal ENC is set to 50%.

In contrast, when the actual event number N per unit time is the threshold N_th or more (YES in step S502), the event number determination circuit 250 sets a low duty ratio for the duty ratio of the row enable signal ENR and/or the column enable signal ENC (step S504), and proceeds to step S505. For example, as illustrated in FIG. 33, the duty ratio of the row enable signal ENR and/or the column enable signal ENC is set to 25%, which is less than 50% (refer to FIG. 32).

In step S505, the event number determination circuit 250 determines whether or not to end the current operation. When the determination is to end the operation (YES in step S505), the event number determination circuit 250 ends the current operation. When the determination is not to end the operation (NO in step S505), the event number determination circuit 250 returns to S501 and executes the subsequent operations.

### 5.3 Action/Effects

As described above, by changing the duty ratio of the row enable signal ENR and/or the column enable signal ENC according to the actual event number per unit time, it is possible to change the cycle for reading out the pixel signal from the unit pixel 310Y. Therefore, for example, even when the firing of the address event per unit time occurs a large number of times, it is still possible to suppress the occurrence of omission of detection of the address events due to the increase in the amount of data processing.

Since other configurations, operations, and effects may be similar to those in the above-described embodiment, detailed description thereof will be omitted here.

### 6. Example of Application to Moving Object

The technology according to the present disclosure (the present technology) is applicable to various products. The technology according to the present disclosure may be applied to devices mounted on any time of moving objects such as automobiles, electric vehicles, hybrid electric vehicles, motorcycles, bicycles, personal mobility, airplanes, drones, ships, and robots.

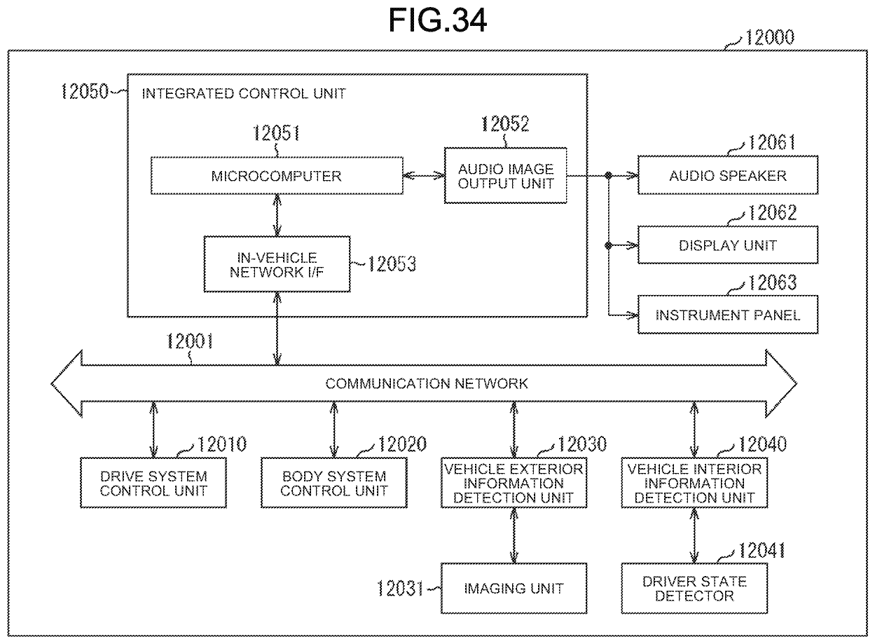

FIG. 34 is a block diagram illustrating a schematic configuration example of a vehicle control system, which is an example of a moving object control system to which the technique according to the present disclosure is applicable.

A vehicle control system 12000 includes a plurality of electronic control units connected via a communication network 12001. In the example illustrated in FIG. 34, the vehicle control system 12000 includes a drive system control unit 12010, a body system control unit 12020, a vehicle exterior information detection unit 12030, a vehicle interior information detection unit 12040, and an integrated control unit 12050. Furthermore, as a functional configuration of the integrated control unit 12050, a microcomputer 12051, an audio image output unit 12052, and an in-vehicle network interface (I/F) 12053 are illustrated.

The drive system control unit 12010 controls the operation of the device related to the drive system of the vehicle in accordance with various programs. For example, the drive system control unit 12010 functions as a control device of a driving force generation device that generates a driving force of a vehicle such as an internal combustion engine or a driving motor, a driving force transmission mechanism that transmits a driving force to the wheels, a steering mechanism that adjusts steering angle of the vehicle, a braking device that generates a braking force of the vehicle, or the like.

The body system control unit 12020 controls the operation of various devices mounted on the vehicle body in accordance with various programs. For example, the body system control unit 12020 functions as a control device for a keyless entry system, a smart key system, a power window device, or various lamps such as a head lamp, a back lamp, a brake lamp, a turn signal lamp, or a fog lamp. In this case, the body system control unit 12020 can receive input of radio waves transmitted from a portable device that substitutes for the key or signals from various switches. The body system control unit 12020 receives the input of these radio waves or signals and controls the door lock device, the power window device, the lamp, or the like, of the vehicle.

The vehicle exterior information detection unit 12030 detects information outside the vehicle equipped with the vehicle control system 12000. For example, an imaging unit 12031 is connected to the vehicle exterior information detection unit 12030. The vehicle exterior information detection unit 12030 causes the imaging unit 12031 to capture an image of the exterior of the vehicle and receives the captured image. The vehicle exterior information detection unit 12030 may perform an object detection process or a distance detection process of people, vehicles, obstacles, signs, or characters on the road surface based on the received image.

The imaging unit 12031 is an optical sensor that receives light and outputs an electrical signal corresponding to the amount of received light. The imaging unit 12031 can output the electric signal as an image and also as distance measurement information. Furthermore, the light received by the imaging unit 12031 may be visible light or invisible light such as infrared light.

The vehicle interior information detection unit 12040 detects vehicle interior information. The vehicle interior information detection unit 12040 is connected to a driver state detector 12041 that detects the state of the driver, for example. The driver state detector 12041 may include a camera that images the driver, for example. The vehicle interior information detection unit 12040 may calculate the degree of fatigue or degree of concentration of the driver or may determine whether the driver is dozing off on the basis of the detection information input from the driver state detector 12041.

The microcomputer 12051 can calculate a control target value of the driving force generation device, the steering mechanism, or the braking device on the basis of vehicle external/internal information obtained by the vehicle exterior information detection unit 12030 or the vehicle interior information detection unit 12040, and can output a control command to the drive system control unit 12010. For example, the microcomputer 12051 can perform cooperative control for the purpose of achieving a function of an advanced driver assistance system (ADAS) including collision avoidance or impact mitigation of vehicles, follow-up running based on an inter-vehicle distance, cruise control, vehicle collision warning, vehicle lane departure warning, or the like.

Furthermore, it is allowable such that the microcomputer 12051 controls the driving force generation device, the steering mechanism, the braking device, or the like, on the basis of the information regarding the surroundings of the vehicle obtained by the vehicle exterior information detection unit 12030 or the vehicle interior information detection unit 12040, thereby performing cooperative control for the purpose of autonomous driving or the like, in which the vehicle performs autonomous traveling without depending on the operation of the driver.

Furthermore, the microcomputer 12051 can output a control command to the body system control unit 12020 based on the vehicle exterior information acquired by the vehicle exterior information detection unit 12030. For example, the microcomputer 12051 can control the head lamp in accordance with the position of the preceding vehicle or the oncoming vehicle sensed by the vehicle exterior information detection unit 12030, and thereby can perform cooperative control aiming at antiglare such as switching the high beam to low beam.

The audio image output unit 12052 transmits an output signal in the form of at least one of audio or image to an output device capable of visually or audibly notifying the occupant of the vehicle or the outside of the vehicle of information. In the example of FIG. 34, an audio speaker 12061, a display unit 12062, and an instrument panel 12063 are illustrated as exemplary output devices. The display unit 12062 may include, for example, at least one of an onboard display and a head-up display.

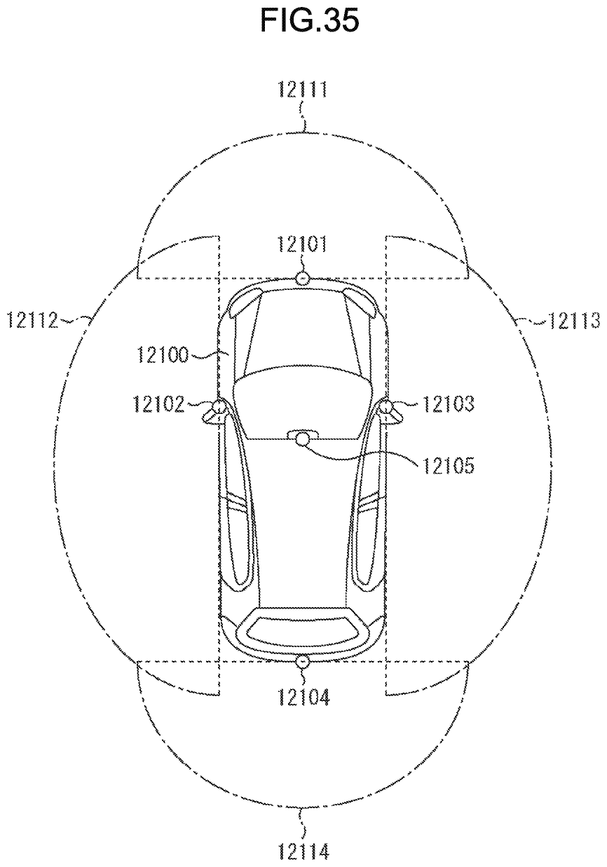

FIG. 35 is a diagram illustrating an example of an installation position of the imaging unit 12031.

In FIG. 35, the imaging unit 12031 includes imaging units 12101, 12102, 12103, 12104 and 12105.

For example, the imaging units 12101, 12102, 12103, 12104, and 12105 are installed at positions on a vehicle 12100, including a front nose, a side mirror, a rear bumper, a back door, an upper portion of the windshield in a vehicle interior, or the like. The imaging unit 12101 provided on the front nose and the imaging unit 12105 provided on the upper portion of the windshield in the vehicle interior mainly acquire an image in front of the vehicle 12100. The imaging units 12102 and 12103 provided in the side mirrors mainly acquire images of the side of the vehicle 12100. The imaging unit 12104 provided on the rear bumper or the back door mainly acquires an image behind the vehicle 12100. The imaging unit 12105 provided at an upper portion of the windshield in the vehicle interior is mainly used for detecting a preceding vehicle or a pedestrian, an obstacle, a traffic light, a traffic sign, a lane, or the like.

Note that FIG. 35 illustrates an example of the imaging range of the imaging units 12101 to 12104. An imaging range 12111 indicates an imaging range of the imaging unit 12101 provided on the front nose, imaging ranges 12112 and 12113 indicate imaging ranges of the imaging units 12102 and 12103 provided on the side mirrors, respectively, and an imaging range 12114 indicates an imaging range of the imaging unit 12104 provided on the rear bumper or the back door. For example, by superimposing pieces of image data captured by the imaging units 12101 to 12104, it is possible to obtain a bird's-eye view image of the vehicle 12100 as viewed from above.

At least one of the imaging units 12101 to 12104 may have a function of acquiring distance information. For example, at least one of the imaging units 12101 to 12104 may be a stereo camera including a plurality of imaging elements, or an imaging element having pixels for phase difference detection.

For example, the microcomputer 12051 can calculate a distance to each of three-dimensional objects in the imaging ranges 12111 to 12114 and a temporal change (relative speed with respect to the vehicle 12100) of the distance based on the distance information obtained from the imaging units 12101 to 12104, and thereby can extract a three-dimensional object traveling at a predetermined speed (for example, 0 km/h or more) in substantially the same direction as the vehicle 12100 being the closest three-dimensional object on the traveling path of the vehicle 12100, as a preceding vehicle. Furthermore, the microcomputer 12051 can set an inter-vehicle distance to be ensured in front of the preceding vehicle in advance, and can perform automatic brake control (including follow-up stop control), automatic acceleration control (including follow-up start control), or the like. In this manner, it is possible to perform cooperative control for the purpose of autonomous driving or the like, in which the vehicle autonomously travels without depending on the operation of the driver.

For example, based on the distance information obtained from the imaging units 12101 to 12104, the microcomputer 12051 can extract three-dimensional object data regarding the three-dimensional object with classification into three-dimensional objects, such as a two-wheeled vehicle, a regular vehicle, a large vehicle, a pedestrian, and other three-dimensional objects such as a utility pole, and can use the data for automatic avoidance of obstacles. For example, the microcomputer 12051 distinguishes obstacles around the vehicle 12100 into obstacles having high visibility to the driver of the vehicle 12100 and obstacles having low visibility to the driver. Subsequently, the microcomputer 12051 determines a collision risk indicating the risk of collision with each of obstacles. When the collision risk is a set value or more and there is a possibility of collision, the microcomputer 12051 can output an alarm to the driver via the audio speaker 12061 and the display unit 12062, and can perform forced deceleration and avoidance steering via the drive system control unit 12010, thereby achieving driving assistance for collision avoidance.

At least one of the imaging units 12101 to 12104 may be an infrared camera that detects infrared rays. For example, the microcomputer 12051 can recognize a pedestrian by determining whether or not a pedestrian is present in the captured images of the imaging units 12101 to 12104. Such pedestrian recognition is performed, for example, by a procedure of extracting feature points in a captured image of the imaging units 12101 to 12104 as an infrared camera, and by a procedure of performing pattern matching processing on a series of feature points indicating the contour of the object to discriminate whether or not it is a pedestrian. When the microcomputer 12051 determines that a pedestrian is present in the captured images of the imaging units 12101 to 12104 and recognizes a pedestrian, the audio image output unit 12052 controls the display unit 12062 to perform superimposing display of a rectangular contour line for emphasis to the recognized pedestrian. Furthermore, the audio image output unit 12052 may control the display unit 12062 to display an icon indicating a pedestrian or the like at a desired position.

Hereinabove, an example of the vehicle control system to which the technology according to the present disclosure is applicable has been described. The technique according to the present disclosure can be applied to the imaging unit 12031, the driver state detector 12041, or the like among the configurations described above.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and a modification as appropriate.

The effects described in individual embodiments of the present specification are merely examples, and thus, there may be other effects, not limited to the exemplified effects.

Note that the present technology can also have the following configurations.

(1)

A solid-state imaging device comprising:

a plurality of unit pixels each of which includes a first photoelectric conversion element that generates an electric charge corresponding to an amount of light received and includes a detector that detects a firing of an address event based on the electric charge generated in the first photoelectric conversion element, the plurality of unit pixels being arranged in a matrix; and

a reset controller that resets one or more first unit pixels in which the firing of the address event has been detected, among the plurality of unit pixels,

wherein the reset controller periodically resets one or more second unit pixels among the plurality of unit pixels.

(2)

The solid-state imaging device according to (1),

wherein the reset controller includes:

a reset circuit that generates a first reset signal for resetting the first unit pixel;

a signal generation circuit that periodically generates a second reset signal for resetting the second unit pixel; and

a logical sum circuit that performs logical sum operation on the reset circuit and the signal generation circuit.

(3)

The solid-state imaging device according to (2),

wherein the signal generation circuit includes a shift register having a plurality of flip-flops connected in multiple stages,

the logical sum circuit is provided one-to-one in each of rows and each of columns of the plurality of unit pixels arranged in the matrix,

each of the plurality of flip-flops has a one-to-one correspondence with each of rows and each of columns of the plurality of unit pixels arranged in the matrix, and

each of the logical sum circuits performs logical sum operation of the second reset signal output from the flip-flop corresponding to the row corresponding to the logical sum circuit and the first reset signal output from the reset circuit, and then outputs a result of the logical sum operation to the first unit pixel or the second unit pixel.

(4)

The solid-state imaging device according to (2) or (3), wherein the signal generation circuit periodically outputs the second reset signal of a predetermined bit pattern to the logical sum circuit.

(5)

The solid-state imaging device according to any one of (2) to (4), wherein the signal generation circuit includes a row signal generation circuit that generates the second reset signal for each of rows in the matrix and a column signal generation circuit that generates the second reset signal for each of columns in the matrix.

(6)

The solid-state imaging device according to (5), wherein at least one of the row signal generation circuit or the column signal generation circuit periodically outputs the second reset signal having a fixed bit pattern to the logical sum circuit.

(7)

The solid-state imaging device according to (4) or (5), wherein the signal generation circuit changes the bit pattern of the second reset signal at a predetermined cycle.

(8)

The solid-state imaging device according to (4) or (5), wherein the signal generation circuit periodically outputs the second reset signal having a random bit pattern to the logical sum circuit.

(9)

The solid-state imaging device according to (8), further comprising

a pseudo-random number generator that generates a pseudo-random number,

wherein the signal generation circuit generates the second reset signal based on the pseudo-random number generated by the pseudo-random number generator.

(10)

The solid-state imaging device according to (3), further comprising

a control circuit that outputs an enable signal that permits or prohibits an output of the second reset signal,

wherein the signal generation circuit further includes a plurality of logical product circuits in which an output of one of the plurality of flip-flops is input to one input and the enable signal is input to the other input.

(11)

The solid-state imaging device according to (10),

wherein the control circuit counts number of unit pixels that have detected the firing of the address event per a predetermined period among the plurality of unit pixels, and outputs the enable signal of a first duty ratio to the signal generation circuit when the number of the unit pixels that have detected the firing of the address event is less than a predetermined threshold, and outputs the enable signal of a second duty ratio lower than the first duty ratio to the signal generation circuit when the number of unit pixels that have detected the firing of the address event is the predetermined threshold or more.

(12)

The solid-state imaging device according to any one of (1) or (11), further comprising

a first arbitration unit that makes an arbitration on a readout order of pixel values regarding the first unit pixel,

wherein the reset controller resets the first unit pixel according to the readout order determined by the arbitration performed by the first arbitration unit.

(13)

The solid-state imaging device according to any one of (1) to (12), wherein each of the unit pixels further includes: a second photoelectric conversion element that generates an electric charge corresponding to the amount of light received; and a generation circuit that generates a detection signal for generating a pixel value based on the electric charge generated in the second photoelectric conversion element.

(14)

The solid-state imaging device according to (13), wherein the generation circuit includes: a capacitor in which one electrode is connected to the second photoelectric conversion element; a comparator that compares a potential of the one electrode of the capacitor with a reference voltage; a switch that switches the reference voltage input to the comparator to one of a first reference voltage or a second reference voltage having a voltage value lower than the first reference voltage; and a logic circuit that outputs a detection signal based on a result of the comparison performed by the comparator.

(15)

The solid-state imaging device according to (14), further comprising a second arbitration unit that generates the pixel value based on a first detection signal output from the logic circuit when the potential of the one electrode of the capacitor falls below the first reference voltage and based on a second detection signal output from the logic circuit when the potential of the one electrode falls below the second reference voltage.

(16)

An imaging device comprising:

a solid-state imaging device;

an optical system that performs focusing of incident light on a light receiving surface of the solid-state imaging device; and

a memory that stores image data acquired by the solid-state imaging device,

wherein the solid-state imaging device includes:

a plurality of unit pixels each of which includes a first photoelectric conversion element that generates an electric charge corresponding to an amount of light received, and a detector that detects a firing of an address event based on the electric charge generated in the first photoelectric conversion element, the plurality of unit pixels being arranged in a matrix; and

a reset controller that resets one or more first unit pixels in which the firing of the address event has been detected among the plurality of unit pixels, and

the reset controller periodically resets one or more second unit pixels among the plurality of unit pixels.

### REFERENCE SIGNS LIST

100 IMAGING DEVICE
110 OPTICAL SYSTEM
120 DSP CIRCUIT
130 DISPLAY UNIT
140 OPERATION UNIT
150 BUS
160 FRAME MEMORY
170 STORAGE UNIT
180 POWER SUPPLY UNIT
190 EXTERNAL I/F
200, 200A, 200B SOLID-STATE IMAGING DEVICE
201 FIRST ARBITER
201A FIRST ROW ARBITER
201B FIRST COLUMN ARBITER
202 RESET CIRCUIT
202A ROW RESET CIRCUIT
202B COLUMN RESET CIRCUIT
203A ROW SIGNAL GENERATION CIRCUIT
203B COLUMN SIGNAL GENERATION CIRCUIT
204A ROW OR CIRCUIT
204B COLUMN OR CIRCUIT
205 SECOND ARBITER
205A SECOND ROW ARBITER
205B SECOND COLUMN ARBITER
209 SIGNAL LINE
220 CONTROL CIRCUIT
231 D-TYPE FLIP-FLOP
232 AND CIRCUIT
240 PSEUDO-RANDOM NUMBER GENERATOR
250 EVENT NUMBER DETERMINATION CIRCUIT
300 PIXEL ARRAY UNIT
310, 310X, 310Y UNIT PIXEL
311 FIRST PHOTODIODE
312 CHARGE DETECTOR
313 SECOND PHOTODIODE
314 CAPACITOR
315 RESET TRANSISTOR
316 COMPARATOR
317 LOGIC CIRCUIT
1000 HOST
G0, G1, G2 IMAGE DATA

1. A solid-state imaging device comprising:
a plurality of unit pixels each of which includes a first photoelectric conversion element that generates an electric charge corresponding to an amount of light received and includes a detector that detects a firing of an address event based on the electric charge generated in the first photoelectric conversion element, the plurality of unit pixels being arranged in a matrix; and
a reset controller that resets one or more first unit pixels in which the firing of the address event has been detected, among the plurality of unit pixels,
wherein the reset controller periodically resets one or more second unit pixels among the plurality of unit pixels.

2. The solid-state imaging device according to claim 1,
wherein the reset controller includes:
a reset circuit that generates a first reset signal for resetting the first unit pixel;
a signal generation circuit that periodically generates a second reset signal for resetting the second unit pixel; and
a logical sum circuit that performs logical sum operation on the reset circuit and the signal generation circuit.

3. The solid-state imaging device according to claim 2,
wherein the signal generation circuit includes a shift register having a plurality of flip-flops connected in multiple stages,
the logical sum circuit is provided one-to-one in each of rows and each of columns of the plurality of unit pixels arranged in the matrix,
each of the plurality of flip-flops has a one-to-one correspondence with each of rows and each of columns of the plurality of unit pixels arranged in the matrix, and
each of the logical sum circuits performs logical sum operation of the second reset signal output from the flip-flop corresponding to the row corresponding to the logical sum circuit and the first reset signal output from the reset circuit, and then outputs a result of the logical sum operation to the first unit pixel or the second unit pixel.

4. The solid-state imaging device according to claim 2, wherein the signal generation circuit periodically outputs the second reset signal of a predetermined bit pattern to the logical sum circuit.

5. The solid-state imaging device according to claim 2, wherein the signal generation circuit includes a row signal generation circuit that generates the second reset signal for each of rows in the matrix and a column signal generation circuit that generates the second reset signal for each of columns in the matrix.

6. The solid-state imaging device according to claim 5, wherein at least one of the row signal generation circuit or the column signal generation circuit periodically outputs the second reset signal having a fixed bit pattern to the logical sum circuit.

7. The solid-state imaging device according to claim 4, wherein the signal generation circuit changes the bit pattern of the second reset signal at a predetermined cycle.

8. The solid-state imaging device according to claim 4, wherein the signal generation circuit periodically outputs the second reset signal having a random bit pattern to the logical sum circuit.

9. The solid-state imaging device according to claim 8, further comprising
a pseudo-random number generator that generates a pseudo-random number,
wherein the signal generation circuit generates the second reset signal based on the pseudo-random number generated by the pseudo-random number generator.

10. The solid-state imaging device according to claim 3, further comprising
a control circuit that outputs an enable signal that permits or prohibits an output of the second reset signal,
wherein the signal generation circuit further includes a plurality of logical product circuits in which an output of one of the plurality of flip-flops is input to one input and the enable signal is input to the other input.

11. The solid-state imaging device according to claim 10,
wherein the control circuit counts number of unit pixels that have detected the firing of the address event per a predetermined period among the plurality of unit pixels, and outputs the enable signal of a first duty ratio to the signal generation circuit when the number of the unit pixels that have detected the firing of the address event is less than a predetermined threshold, and outputs the enable signal of a second duty ratio lower than the first duty ratio to the signal generation circuit when the number of unit pixels that have detected the firing of the address event is the predetermined threshold or more.

12. The solid-state imaging device according to claim 1, further comprising
a first arbitration unit that makes an arbitration on a readout order of pixel values regarding the first unit pixel,
wherein the reset controller resets the first unit pixel according to the readout order determined by the arbitration performed by the first arbitration unit.

13. The solid-state imaging device according to claim 1, wherein each of the unit pixels further includes: a second photoelectric conversion element that generates an electric charge corresponding to the amount of light received; and a generation circuit that generates a detection signal for generating a pixel value based on the electric charge generated in the second photoelectric conversion element.

14. The solid-state imaging device according to claim 13, wherein the generation circuit includes: a capacitor in which one electrode is connected to the second photoelectric conversion element; a comparator that compares a potential of the one electrode of the capacitor with a reference voltage; a switch that switches the reference voltage input to the comparator to one of a first reference voltage or a second reference voltage having a voltage value lower than the first reference voltage; and a logic circuit that outputs a detection signal based on a result of the comparison performed by the comparator.

15. The solid-state imaging device according to claim 14, further comprising a second arbitration unit that generates the pixel value based on a first detection signal output from the logic circuit when the potential of the one electrode of the capacitor falls below the first reference voltage and based on a second detection signal output from the logic circuit when the potential of the one electrode falls below the second reference voltage.

16. An imaging device comprising:
a solid-state imaging device;
an optical system that performs focusing of incident light on a light receiving surface of the solid-state imaging device; and
a memory that stores image data acquired by the solid-state imaging device,
wherein the solid-state imaging device includes:
a plurality of unit pixels each of which includes a first photoelectric conversion element that generates an electric charge corresponding to an amount of light received, and a detector that detects a firing of an address event based on the electric charge generated in the first photoelectric conversion element, the plurality of unit pixels being arranged in a matrix; and
a reset controller that resets one or more first unit pixels in which the firing of the address event has been detected among the plurality of unit pixels, and
the reset controller periodically resets one or more second unit pixels among the plurality of unit pixels.
